(19) United States
(12) Patent Application Publication
(10) Pub. No.: US 2011/0004579 A1
(43) Pub. Date: Jan. 6, 2011

(54) Neuromorphic Circuit

(76) Inventor: Greg Snider, Los Altos, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/865,512

(22) PCT Filed: Sep. 29, 2008
(86) PCT No.: PCT/US08/11274

§ 371 Date: Jul. 30, 2010

Related U.S. Application Data
(60) Provisional application No. 61/036,864, filed on Mar. 14, 2008.

(51) Int. Cl. G06N 3/08; G06F 15/18

(52) U.S. Cl. 706/25; 706/26

(57) ABSTRACT

Embodiments of the present invention are directed to neuromorphic circuits containing two or more internal neuron computational units. Each internal neuron computational unit includes a synchronization-signal input for receiving a synchronizing signal, at least one input for receiving input signals, and at least one output for transmitting an output signal. A memristive synapse connects an output signal line carrying output signals from a first set of one or more internal neurons to an input signal line that carries signals to a second set of one or more internal neurons.

### CROSS-REFERENCE TO RELATED APPLICATION

This application claims the benefit of Provisional Application No. 61/036,864, filed Mar. 14, 2008.

### TECHNICAL FIELD

The present invention is related to electronics and computer hardware and; in particular, to a method for, and a system that carries out, machine learning through changes in the physical properties of synapse-like junctions in neuromorphic circuits.

### BACKGROUND OF THE INVENTION

Early in the history of computing, computer scientists became interested in biological computing structures, including the human brain. Although sequential-instruction-processing engines have technologically evolved with extreme rapidity during the past 50 years, with enormous increases in processor speeds and component densities, although these advancements have been accompanied by even greater increases in the capacities and access speeds of mass-storage devices and random-access memories, and although modern computer systems based on sequential-instruction-processing engines provide enormous utility and have spawned entire new industries unimagined prior to the development of digital computers, many seemingly straightforward problems can still not be effectively addressed by even the largest and highest-speed distributed computer systems and networks. One trivial example is the interpretation of photographs and video images. A human can, often in a fraction of a second, glance at a photograph and accurately interpret objects, interrelationships between objects, and the spatial organization of objects represented by the two-dimensional photograph, while equivalent interpretation of photographic images is beyond the ability of the largest computer systems running the most cleverly designed algorithms. In addition, the steep, two-fold increase in processing power and feature density every two years that has characterized computer evolution, referred to as “Moore's Law,” has begun to flatten, with further decreases in feature sizes now encountering physical limitations and practical constraints, including increasing electrical resistivity as signal lines diminish in size, increasing difficulty in removing heat from processors that produce increasing amounts of heat due to increases in the capacitance of features as feature sizes diminish, higher defect and failure rates in processor and memory components due to difficulties encountered in manufacturing ever smaller features, and difficulties in designing manufacturing facilities and methodologies to further decrease feature sizes.

As further reductions in feature sizes within integrated circuits prove increasingly difficult, a variety of alternative approaches to increasing the computational power of integrated-circuit-based electronic devices have begun to be employed. As one example, processor vendors are producing multi-core processors that increase computational power by distributing computation over multiple cores that execute various tasks in parallel. Other efforts include fabricating circuitry at the nanoscale level, using various molecular electronics techniques, and addressing defect and reliability issues by applying theoretical approaches based on information science in similar fashion to the use of error-correcting codes to ameliorate faulty transmission of data signals through electronic communications media.

In addition to the efforts to increase performance by improving and enhancing traditional computing approaches, various non-traditional approaches are being investigated, including biological computing. Extensive research efforts have been expended in investigating the structure and function of the human brain. Many of the fundamental computational entities in such biological systems have been identified and characterized physiologically, at microscale dimensions as well as at the molecular level. For example, the neuron, a type of cell responsible for signal processing and signal transmission within the human brain, is relatively well understood and well characterized, although much yet remains to be learned. This understanding of neuron function has inspired a number of fields in computer science, including neural-network and perceptron-network subfields of artificial intelligence. Many successful software implementations of neural networks have been developed to address a variety of different applications, including pattern recognition, diagnosis of the causes of complex phenomena, various types of signal processing and signal denoising, and other applications. However, the human brain is massively parallel from a structural standpoint, and while such parallelism can be simulated by software implementations and neural networks, the simulations are generally processor-cycle bound, because the simulations necessarily run on one or a relatively small number of sequential instruction-processing engines, rather make use of physical parallelism within the computing system. Thus, neural networks may provide tolerance to noise, learning capabilities, and other desirable-characteristics, but do not currently provide the extremely fast and high-bandwidth computing capabilities of massively parallel biological computational structures.

In order to achieve the extremely fast and high-bandwidth computing capabilities of biological computational structures in physical, manufactured devices, computational tasks need to be carried out on massively parallel and interconnected networks of computational nodes. Many different approaches for implementing physical neural networks have been proposed, but implementations have so far have fallen fall short of the speed, parallelism, and computational capacity of even relatively simple biological structures. In addition, design and manufacture of massively parallel hardware is fraught with any number of different practical problems, including reliable manufacture of large numbers of dynamical connections, size and power constraints, heat dissipation, reliability, flexibility, including programmability, and many other such considerations. However, unlike many theoretical problems, for which it is unclear whether or not solutions can be found, the fact that computational biological structures, including the human brain, exist, and perform spectacular feats of computation on a regular basis would suggest that the goal of designing and constructing computational devices with similar computational capacities and efficiencies is quite possible.

Current efforts are directed to developing nanoscale circuitry, referred to as “neuromorphic circuitry,” that mimics biological neural circuitry that provides biological organisms with spectacularly efficient, low-power, parallel computational machinery. However, many current approaches employ conventional logic implemented in complementary metal oxide semiconductor (“CMOS”) technologies to implement neuromorphic-circuitry-equivalents to synapses, severely limiting the density at which the neuromorphic-circuitry-equivalents to neurons can be fabricated, generally to a few thousand neurons per square centimeter of semiconductor-chip surface area. Various approaches have been proposed for implementing neuromorphic circuits using memristive, synapse-like junctions that interconnect neuron computational units implemented in lithography-based logic circuits. In many of these proposed implementations, the overall circuitry ends up constrained by the physical properties of the memristive junctions, and undesirable levels of power dissipation is a frequently-encountered and difficult-to-ameliorate problem. Therefore, researchers and developers of neuromorphic circuitry, manufacturers and vendors of devices that include neuromorphic circuitry, and, ultimately, users of devices that include neuromorphic circuitry continue to develop neuromorphic-circuit implementations and related methods that provide for flexible, practical, and low-power synapse-like learning through controlled and deterministic changes of the physical properties of synapse-like junctions within the neuromorphic circuits.

### SUMMARY OF THE INVENTION

Embodiments of the present invention are directed to neuromorphic circuits containing two or more internal neuron computational units. Each internal neuron computational unit includes a synchronization-signal input for receiving a synchronizing signal, at least one input for receiving input signals, and at least one output for transmitting an output signal. A memristive synapse connects an output signal line carrying output signals from a first set of one or more internal neurons to an input signal line that carries signals to a second set of one or more internal neurons.

### BRIEF DESCRIPTION OF THE DRAWINGS

FIG. 1 shows a generalized and stylized illustration of a neuron.

FIG. 2 shows a more abstract representation of a neuron.

FIG. 3 is an abstract representation of a neuron cell, showing the different types of electrochemical gradients and channels in the neuron's outer membrane that control, and respond, to electrochemical gradients and signals and that are used to trigger neuron output signal firing.

FIGS. 4-5 illustrate neuron firing.

FIG. 6 illustrates a model for the dynamic synapse-strength phenomenon.

FIG. 7 shows a typical neural-network node.

FIGS. 8-9 illustrate two different examples of activation functions.

FIG. 10 shows a simple, three-level neural network.

FIGS. 11A-B illustrate the memristive characteristics of nanowire junctions that can be fabricated by currently available techniques.

FIGS. 12A-E illustrate memristive, nanowire-junction conductance, over time, with respect to voltage signals applied to two signal lines that are connected by a memristive, nanowire junction.

FIG. 13 shows a basic computational cell of a hybrid microscale-nanoscale neuromorphic integrated circuit.

FIG. 14 illustrates a memristive junction between two nanowires that models synapse behavior.

FIGS. 15A-B illustrate the essential electronic properties of memristive junctions employed to model synapses.

FIG. 16 shows a neural cell that serves as a basic computational unit in various embodiments of a hybrid microscale-nanoscale neuromorphic integrated circuit.

FIGS. 17A-B illustrate interconnection of computational cells within a hybrid microscale-nanoscale neuromorphic integrated circuit.

FIG. 18 illustrates hierarchical interconnection of computational cells within a hybrid microscale-nanoscale neuromorphic integrated circuit.

FIGS. 19A-C illustrate several of the illustration conventions used in subsequent figures.

FIG. 20 illustrates a small portion of an exemplary neuromorphic circuit.

FIGS. 21A-22B illustrate pulse-width-modulation-based representation of an exponential-decay function.

FIG. 23 shows a symbolic representation of a neuron, within a neuromorphic circuit that represents an embodiment of the present invention, that can transmit signals through memristive synapses in synchrony with signal transmission by other neurons.

FIG. 24 illustrates a basic signal-synchronization model according to embodiments of the present invention.

FIGS. 25A-B illustrate pulse-width-modulation representation of two different exponential-decay functions.

FIG. 26 shows two neurons within a neuromorphic circuit and alphanumeric labels for their output and inputs according to embodiments of the present invention.

FIGS. 27A-F illustrate the constant-voltage-pulse signals generated and transmitted by neurons in a neuromorphic circuit according to embodiments of the present invention.

FIGS. 28A-29E illustrate one implementation of neuromorphic-circuit-neuron signal-processing logic that generates the synchronized signals shown in FIG. 27A-F according to embodiments of the present invention.

FIG. 30 shows one possible implementation of a virtual ground circuit that may be used to connect input signals to neurons according to embodiments of the present invention.

### DETAILED DESCRIPTION OF THE INVENTION

The present invention is directed to neuromorphic circuits and methods carried out by, or implemented in, neuromorphic circuits to provide machine learning by controlled and deterministic changes in the physical states of synapse-like junctions through which neurons of the neuromorphic circuit are interconnected. In a first subsection, below, an overview of neuromorphic circuits and synapse-like junctions are provided. In a second subsection, method and system embodiments of the present invention are discussed.

### Neuromorphic Circuits and Synapse-Like Junctions

### Within Neuromorphic Circuits

### Biological Neurons

Neurons are a type of cell found in the brains of animals. Neurons are thought to be one of, if not the, fundamental biological computational entity. It is estimated that the human brain contains on the order of 100 billion (10¹¹) neurons and on the order of 100 trillion (10¹⁴) interconnections between neurons. The massive number of interconnections between neurons in the human brain is thought to be directly correlated with the massively parallel nature of biological computing.

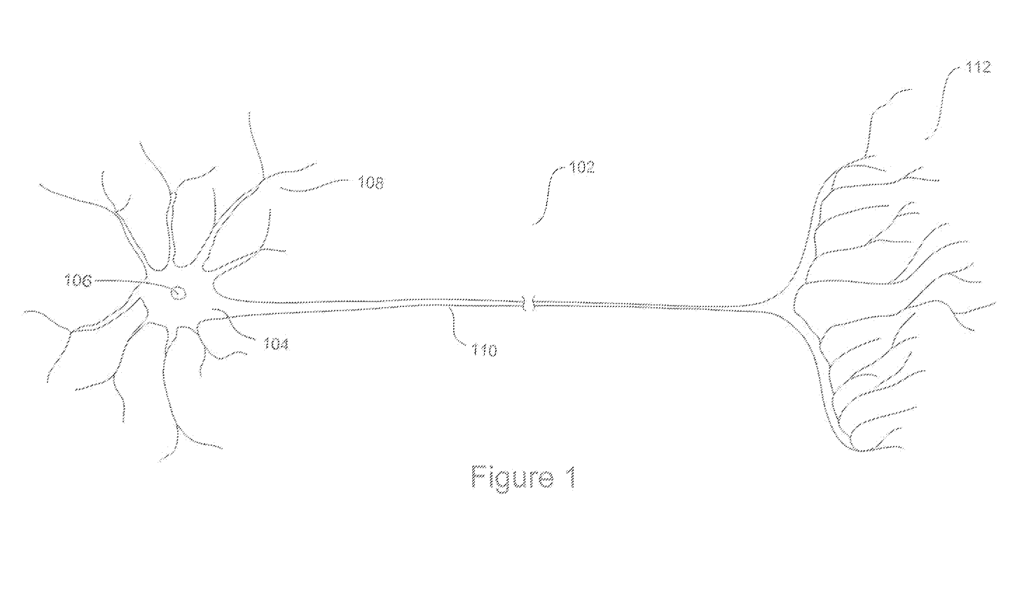

Each neuron is a single cell. FIG. 1 shows a generalized and stylized illustration of a neuron. The neuron 102 includes a cell body 104 containing the cell nucleus 106 and various organelles, including mitochondria, a number of branching dendrites, such as dendrite 108, emanating from the cell body 104, and generally one very long axon 110 that terminates in many branching extensions 112. In general, the dendrites provide an enlarged neuron-surface area for receiving signals from other neurons, while the axon serves to transmit signals from the neuron to other neurons. The terminal branches of the axon 112 interface with the dendrites, and less frequently with the cell bodies, of other neurons. A single neuron may receive as many as 100,000 different signal inputs. Similarly, a neuron may transmit signals to tells, hundreds, or even thousands of downstream neurons. Neurons vary tremendously, within a given individual, with respect to the number of and degree of branching of, dendrites and terminal axon extensions as well as with respect to volume and length. For example, axons range in length from significantly less than one millimeter to over one meter. This flexibility in axon length and connectivity allow for hierarchical cascades of signal paths and extremely complex connection-based organizations of signaling paths and cascades within the brain.

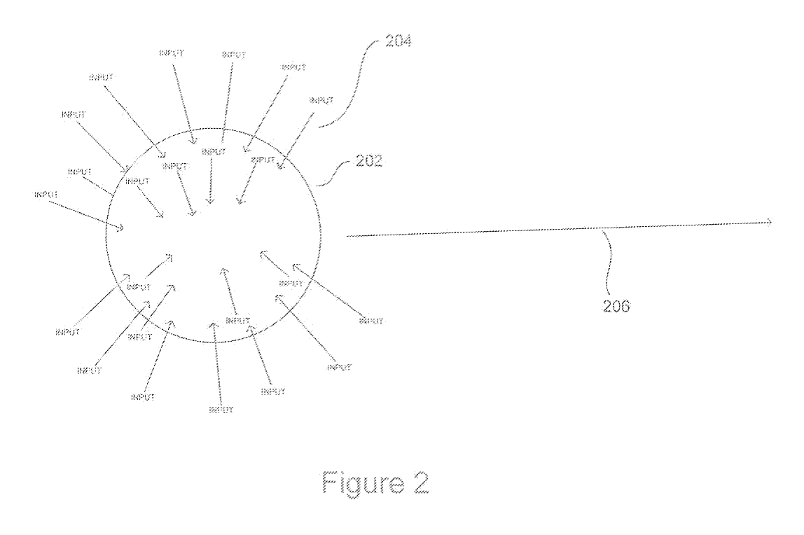

FIG. 2 shows a more abstract representation of a neuron. A neuron can, in general, be thought of as a node 202 that receives input signals from multiple inputs, such as input 204, and depending on the temporal and spatial characteristics of the inputs, responds to input stimuli of greater than a threshold intensity by tiring an output signal 206. In other words, the neuron can be thought of as a very complex input-signal integrator combined with a thresholder and a signal-generation and signal-output mechanism. When the signal integrator accumulates a sufficient number of input signals over a bounded period of time and within a sufficiently small area of the node surface, the neuron responds by firing an output signal.

As mentioned above, input signals received by a given neuron are generated by output signals of other neurons connected to the given neuron by synapse junctions between the other neurons' terminal axon branches and the given neuron's dendrites. These synapses, or connections, between neurons have dynamically adjusted connection strengths, or weights. The adjustment of the connection strengths, or weights, is thought to significantly contribute to both learning and memory, and represents a significant portion of parallel computation within the brain.

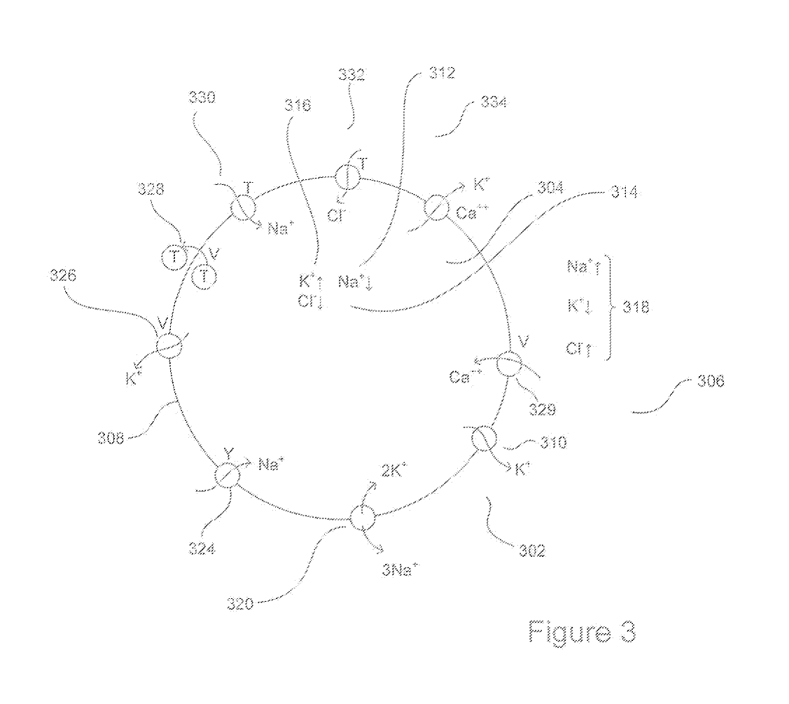

Neuron functionalities are derived from, and depend on, complex electrochemical gradients and ion channels. FIG. 3 is an abstract representation of a neuron cell, showing the different types of electrochemical gradients and channels in the neuron's outer membrane that control, and respond, to electrochemical gradients and signals and that are used to trigger neuron output signal firing. In FIG. 3, the neuron is represented as a spherical, membrane-enclosed cell 302, the contents of which 304 are separated from the external environment 306 by a double-walled, hydrophobic membrane 308 that includes various types of channels, such as channel 310. The various types of channels provide for controlled chemical communication between the interior of the neuron and the external environment.

The channels primarily responsible for neuron characteristics are highly selective ion channels that allow for transport of particular inorganic ions from the external environment into the neuron and/or from the interior of the neuron to the external environment. Particularly important inorganic ions include sodium, Na⁺, potassium, K⁺, calcium, Ca²⁺, and chlorine, Cl⁻, ions. The ion channels are generally not continuously open, but are selectively opened and closed in response to various types of stimuli. Voltage-gated channels open and close depending on the voltage, or electrical field, across the neuron membrane. Other channels are selectively opened and closed by mechanical stress, and still other types of channels open and close in response to binding and release of ligands, generally small-molecule organic compounds, including neurotransmitters. Ion-channel behavior and responses may additionally be controlled and modified by the addition and deletion of certain functional groups to and from ion-channel proteins, carried out by various enzymes, including kinases and phosphatases, that are, in turn, controlled by various types of chemical signal cascades.

In general, in a resting, or non-firing state, the neuron interior has a relatively low concentration of sodium ions 312, a correspondingly low concentration of chlorine ions 314, and a relatively high concentration of potassium ions 316 with respect to the concentrations of these ions in the external environment 318. In the resting state, there is a significant 40-50 mV electrochemical gradient across the neuron membrane, with the interior of the membrane electrically negative with respect to the exterior environment. The electrochemical gradient is primarily generated by an active Na⁺—K⁺ pumping channel 320 which uses chemical energy, in the form of adenosine triphosphate, to continuously exchange three sodium ions expelled the interior of the neuron to the external environment for every two potassium ions imported from the external environment into the interior of the neuron. The neuron also contains passive K⁺ leak channels 310 that allow potassium ions to leak back to the external environment from the interior of the neuron. This allows the potassium ions to come to an equilibrium with respect to ion-concentration gradient and the electrical gradient.

Neuron tiring, or spiking, is triggered by a local depolarization of the neuron membrane. In other words, collapse of the normally negative electrochemical gradient across a membrane results in triggering of an output signal. A wave-like, global depolarization of the neuron membrane that represents neuron firing is facilitated by voltage-gated sodium channels 324 that allow sodium ions to enter the interior of the neuron down the electrochemical gradient previously established by the Na⁺—K⁺ pump channel 320. Neuron firing represents a short pulse of activity, following which the neuron returns to a pre-firing-like state, in which the normal, negative electrochemical gradient across the neuron membrane is reestablished. Voltage-gated potassium channels 326 open in response to membrane depolarization to allow an efflux of potassium ions, down the chemical potassium-ion gradient, in order to facilitate reestablishment of an electrochemical gradient across the neuron membrane following firing. The voltage-gated potassium channels 324, opened by local depolarization of the neuron membrane, are unstable, in the open state, and relatively quickly move to an inactivated state to allow the negative membrane potential to be reestablished, both by operation of the voltage-gated potassium channel 326 and the Na⁺—K⁺ channel/pump 320.

Neuron-membrane depolarization begins at a small, local region of the neuron cell membrane and sweeps, in a wave-like fashion, across the neuron cell, including down the axon to the axon terminal branches. Depolarization at the axon terminal branches triggers voltage-gated neurotransmitter release by exocytosis 328. Release of neurotransmitters by axon terminal branches into synaptic regions between the axon terminal branches of the firing neuron, referred to as the “pre-synaptic neuron,” and dendrites of the signal-receiving neurons, each referred to as a “post-synaptic neuron,” results in binding of the released neurotransmitter by receptors on dendrites of post-synaptic cells that results in transmission of the signal from the pre-synaptic neuron to the post-synaptic neurons. In the post-synaptic neurons, binding of transmitters to neurotransmitter-gated ion channels 330 and 332 results in excitatory input signals and inhibitory input signals, respectively. Neurotransmitter-gated ion channels that import sodium ions into the neuron 330 contribute to local depolarization of the neuron membrane adjacent to the synapse region, and thus provide an excitatory signal. By contrast, neurotransmitter-activated chlorine-ion channels 332 result in import of negatively charged chlorine ions into the neuron cell, resulting in restoring or strengthening the normal, resting negative voltage gradient across the membrane, and thus inhibit localized membrane depolarization and provide an inhibitory signal. Neurotransmitter release is also facilitated by voltage-gated calcium ion channels 329 that allow calcium influx into the neuron.

A Ca²⁺ activated potassium channel 334 serves to decrease the depolarizability of the membrane following a high frequency of membrane depolarization and signal firing that results in build up of calcium ions within the neuron. A neuron that has been continuously stimulated for a prolonged period therefore becomes less responsive to the stimulus. Early potassium-ion channels serve to reduce neuron firing levels at stimulation levels close to the threshold stimulation required for neuron firing. This prevents an all-or-nothing type of neuron response about the threshold stimulation region, instead providing a range of frequencies of neuron firings that correspond to a range of simulations of the neuron. The amplitude of neuron firing is generally constant, with output-signal strength reflecting in the frequency of neuron firing.

Another interesting feature of the neuron is long-term potentiation. When a pre-synaptic cells fires at a time when the post-synaptic membrane is strongly depolarized, the post-synaptic cell may become more responsive to subsequent signals from the pre-synaptic neuron. In other words, when pre-synaptic and post-synaptic neuron firings occur close in time, the strength, or weighting, of the interconnection may increase.

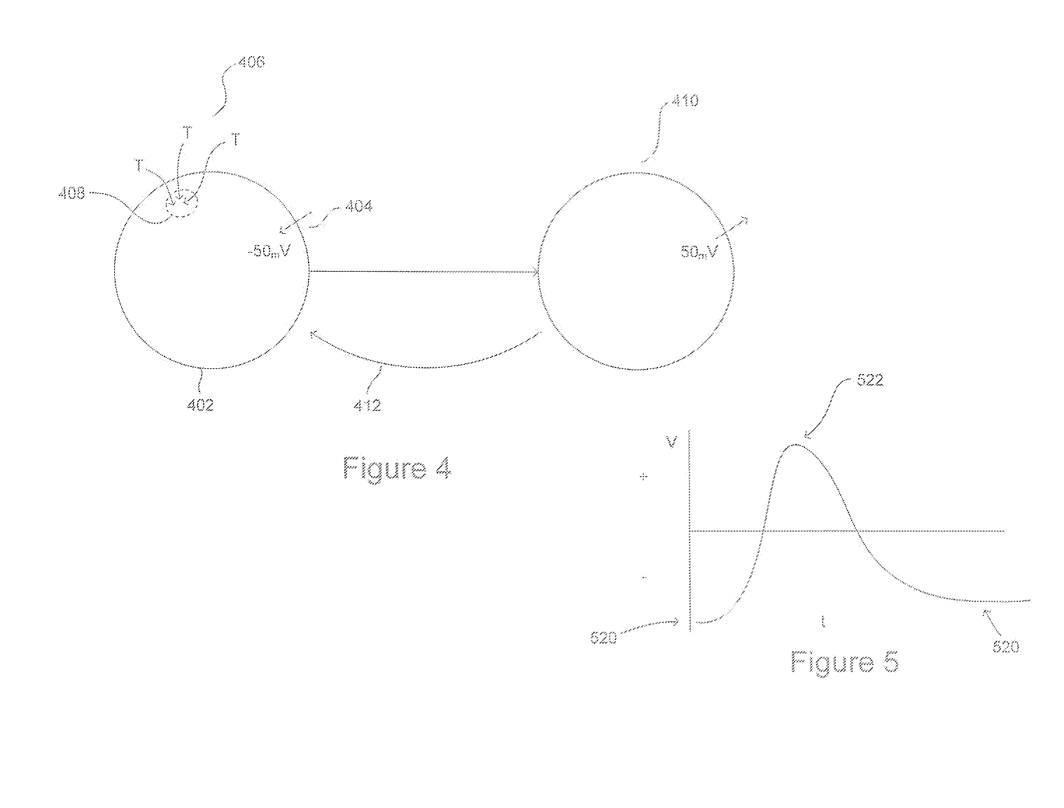

FIGS. 4-5 illustrate neuron firing. In FIG. 4, the resting-state neuron 402 exhibits a negative voltage gradient across a membrane 404. As the resting neuron receives neurotransmitter-mediated signal input 406, a small region 408 of the neuron membrane may receive sufficient access of stimulatory signal input over inhibitory signal input to depolarize the small region of the neuron membrane 408. This local depolarization activates the voltage-gated sodium channels to generate a wave-like global depolarization that spreads across the neuron membrane and down the axon, temporarily reversing the voltage gradient across the neuron membrane as sodium ions enter the neuron along the sodium-ion-concentration gradient. The reversal of the voltage gradient places the neuron into a firing, or spiking state, in which, as discussed above, terminal branches of the axon release neurotransmitter signals into synapses to signal post-synaptic neurons. The voltage-gated sodium channels quickly become inactivated, voltage-gated potassium channels open, and the resting-state negative voltage gradient is quickly restored 412. FIG. 5 shows the voltage gradient reversal at the point on the neuron membrane during a spike or a firing. In general, the voltage gradient is negative 520, but temporarily reverses 522 during the wave-like membrane depolarization that represents neuron firing or spiking and propagation of the output signal down the axon to the terminal braches of the axon

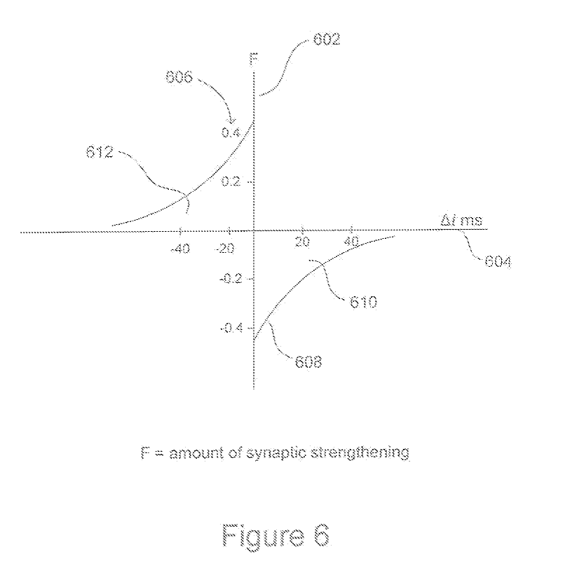

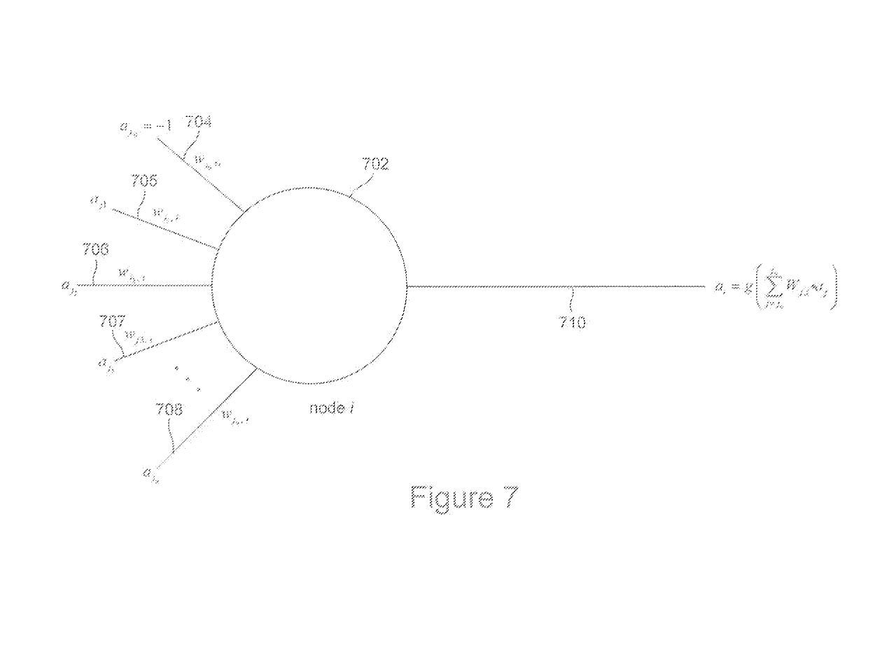

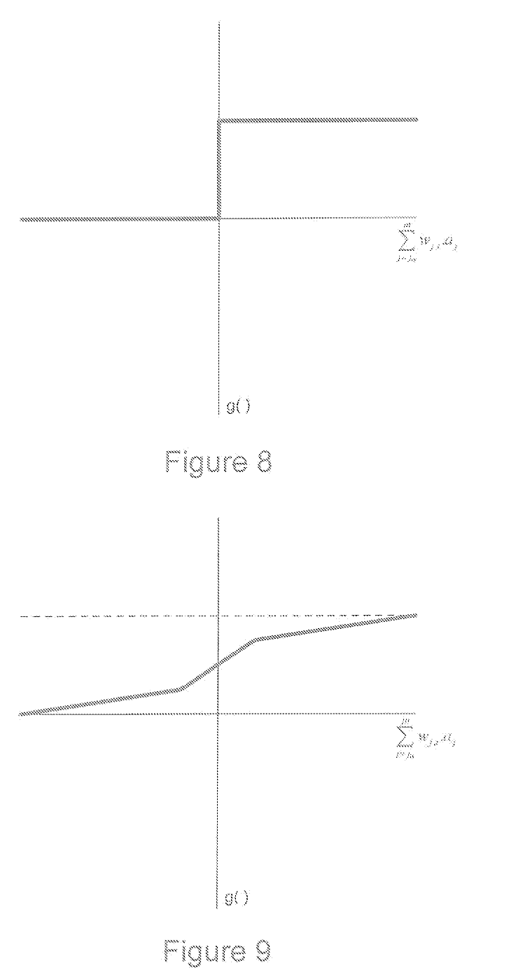

FIG. 6 illustrates a model for the dynamic synapse-strength phenomenon. FIG. 6 is a plot of synapse strengthening F, plotted with respect to the vertical axis 602, versus the time difference between pre-synaptic and post-synaptic spiking, plotted as Δt along the horizontal axis 604. When the pre-synaptic neuron fires close in time, but prior to, firing of the post-synaptic neuron, the amount of synapse strengthening is relatively high, represented by the steeply increasing portion of the plotted curve 606 to the left of the vertical axis. This portion of the plot of F corresponds to Hebbian learning, in which correlations in the firing of post-synaptic and pre-synaptic neurons lead to synapse strengthening. By contrast, when the pre-synaptic neuron fires just after firing of the post-synaptic-neuron, then the synaptic strength is weakened, as represented by the steeply upward curving portion 608 of the plotted curve to the right of the vertical axis. When firing of the pre-synaptic and post-synaptic neurons is not correlated in time, or, in other words, Δt is large in magnitude, the strength of the synapse is not greatly affected, as represented by portions of the plotted curve that approach the horizontal axis at increasing distance from the origin. The synapse weakening response to pre-synaptic and post-synaptic neuron-firing correlations, represented by the area above the right-hand portion of the curve 610, may not, be equal to the synapse strengthening due to correlation between pre-synaptic and post-synaptic neuron firing, represented by the area under the left-hand portion of the plotted curve 612.

In summary, neurons serve as somewhat leaky input-signal integrators combined with a thresholding function and an output-signal generation function. A neuron tires with increasing frequency as excitatory stimulation of the neuron increases, although, over time, the neuron response to constant high stimulus decreases. Synapses, or junctions, between neurons may be strengthened or weakened by correlations in pre-synaptic and post-synaptic neuron firings. In addition, and synapse strength and neuron stimulation both decay, over time, without reinforcing stimulus. Neurons provide a fundamental computational unit for massively parallel neuronal networks within biological organisms as a result of the extremely high density of connections between neurons supported by the highly branched dendrites and axon terminus branches, as well as by the length of axons.

### Neural Networks and Perceptron Networks

Neural networks, considered to be a field of artificial intelligence, originally motivated by attempts to simulate and harness biological signal-processing and computation, have proven sufficiently effective and useful that researchers and developers are currently attempting to build neural networks directly in hardware as well as developing specialized hardware platforms for facilitating software implementations of neural networks. Neural networks are essentially networks of computational interconnected nodes. FIG. 7 shows a typical neural-network node. It is not surprising that a neural network node is reminiscent of the model of the neuron shown in FIG. 2. A neural network node 702 receives inputs from a number n of directed links 705-708 as well as a special link j₀, and produces an output signal on an output link 710 that may branch, just as an axon branches, to transmit signals to multiple different downstream nodes. The directed input links 705-708 are output signals, or branch from output signals, of upstream nodes in the neural network, or, in the case of first-level nodes, are derived from some type of input to the neural network. The upstream nodes are each associated with an activation, which, in certain implementations, ranges from 0 to 1. Each input link is associated with a weight. Thus, the neural-network node i shown in FIG. 7 receives n inputs j₁, j₂, . . . , jₙ from n upstream neural-network nodes having activations aⱼ₁, aⱼ_{₂}, . . . , aⱼ_{ₙ}, with each input j₁, j₂, . . . jₙ associated with corresponding current weight wⱼ_{₁}_{,i}, wⱼ_{₂}_{,i}, . . . , wⱼ_{ₙ}_{,i}. In other words, the activation is a property of nodes, and the weights are a property of links between nodes. The neural network node i computes an activity aᵢ from received, weighted input signals, and outputs a signal corresponding to the computed activity aᵢ on the output signal line 710. As shown in FIG. 7, a very simplistic model for a neuron can be expressed as:

$${a}_{i} = g ( {\sum }_{j = {j}_{0}}^{jn} {w}_{j , i} \cdot {a}_{j} )$$

where g( ) is a non-linear activation function. FIGS. 8-9 illustrate two different examples of activation functions. The special input signal line j₀ represents an internal bias with a fixed activation aⱼ_{₀}=−1. The weight wⱼ_{ₒ}, associated with this internal bias is used to set the threshold for the node. When the sum of the weighted activations input from the actual input signal lines j₁, j₂, . . . jₙ exceeds the bias weight of wⱼ_{₀},ᵢ, then the neuron is active, and outputs signal aᵢ. The first activation function g( ) shown in FIG. 8 represent a hard threshold, while the second activation function g( ) shown in FIG. 9 provides a soil threshold. In more general models for neurons, neuron output firing is a function of the past history of weighted inputs to the neuron, is often stochastic, and does not therefore necessarily employ thresholds. The output signal aᵢ may have any of various different forms, and may reflect the degree of neuron activity by any of various means, including by varying the duration of spike output, frequency of spike, output, the magnitude of each spike in voltage or current, by varying voltage or current of a linear signal, or by any of other means of encoding information in a signal.

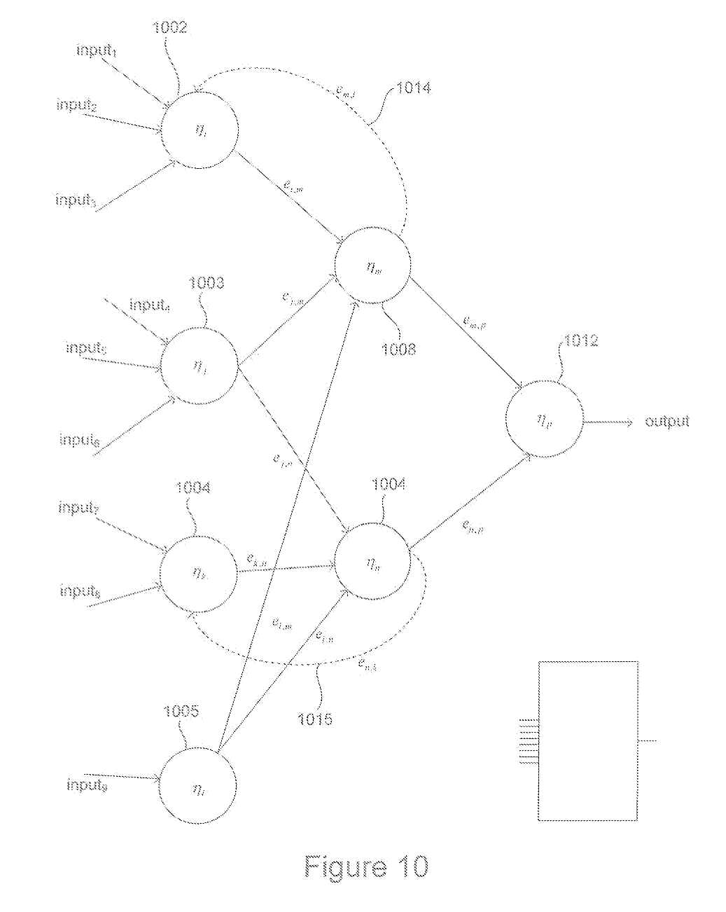

FIG. 10 shows a simple, three-level neural network. The neural network includes four input nodes 1002-1005, two intermediate nodes 1008-1009, and a highest-level, output node 1012. The input nodes 1002-1005 each receive one or more inputs to the neural network and each produce output signals that are directed through internal connections, or edges, to one or more of the intermediate nodes 1008 and 1009. In turn, the intermediate nodes produce output signals to edges connecting the intermediate nodes to the output node 1012. A neural network in which signals are directed in only one direction along edges, from input nodes towards output nodes, is referred to as a “feed-forward network,” while neural networks that include feedback edges, such as edges 1014-1015 in FIG. 10, that allow signals to propagate from higher-level nodes back to lower-level nodes, is referred to as a “recurrent network.” Multi-layer neural networks can be used to represent general non-linear functions of arbitrary dimensionality and complexity, assuming the ability to include a corresponding arbitrary number nodes in the neural network.

Once trained, a neural network responds to input signals by generating output signals, generally implementing a complex, non-linear function. Neural networks can also be intermittently or continuously retrained, so that, over time, the complex non-linear function represented by the neural network reflects previous signal-processing experience.

Physical Node Implementations for Neural-Network, Perceptron-Network, and Other Parallel, Distributed, Dynamical Network Nodes that Represents Various Embodiments of the Present Invention

Most neural-network-based systems, to date, are essentially software simulations of neural network behavior. Nodes are implemented as data structures and accompanying routines, and the nodes and edge weights are iteratively updated in conventional, sequential-instruction-execution fashion. As a result, although many useful characteristics of neural networks can be exploited, the neural networks do not provide the computational speeds obtained in truly parallel computing systems, including the human brain. Moreover, simulation of neuron-like functionalities, including edge-weight dynamics and leaky integration, may be fairly computationally expensive, particularly when carried out repetitively, in sequential fashion.

For this reason, there have been many attempts to build physical neural networks using a variety of different implementation strategies and materials. However, to date, no physical implementation has come even close to the density and computational efficiency of even simple biological signal-processing structures. Problems include providing for large numbers of dynamical connections, a variety of manufacturing and assembly constraints, problems with heat dissipation, problems with reliability, and many other problems.

It turns out that the memristive characteristics of nanowire junctions, and a host of other memristive materials, including various nanoscale metal-oxide features, that represent an annoyance for fabricating nanoscale circuits analogous to traditional logic circuits are the characteristics needed for dynamical edges in neural networks and other parallel, distributed, dynamic processing networks comprising interconnected computational nodes. Thus, a relatively simply fabricated, nanoscale nanowire junction provides the functionality for a dynamical edge at nanoscale size, without the need for programming or algorithmic computation. Because the number of connections between nodes vastly exceeds the number of nodes in most naturally occurring signal-processing and computational structures, including the human brain, it is desirable that the connections used to implement a hardware network of computational nodes be small, easily fabricated, and have intrinsic, physical characteristics close to those needed for edges, or synapses, so that the dynamical nature of connections need not be programmed into the hardware or simulated by hardware-based logic circuits.

### Memristic Materials

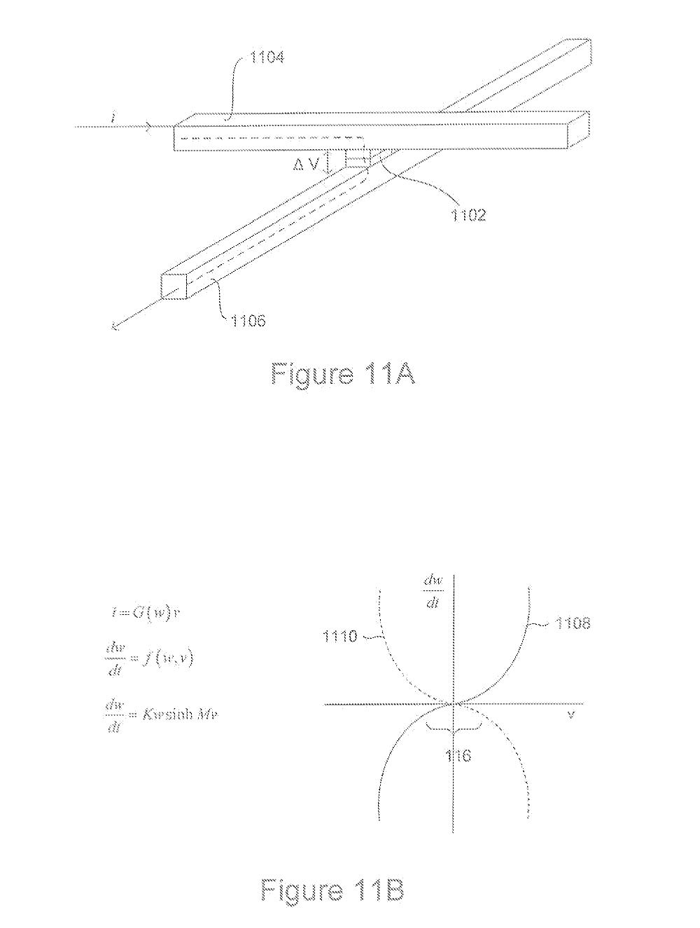

FIGS. 11A-B illustrate the memristive characteristics of nanowire junctions that can be fabricated by currently available techniques. FIG. 11A illustrates a single nanowire junction. The nanowire junction comprises one or more layers of memristive material 1102 at the junction between a first, input nanowire 1104 and a second, output nanowire 1106. The current follows the following current model, within certain current ranges and voltage ranges:

i=G(w,v)

where w is a state variable of the junction, v is the voltage applied across the junction, and G(w,v) is the conductance of the junction, which generally varies non-linearly with respect to voltage. The rate of change of the state variable with respect to time is a function both of the value of the state variable and the voltage applied to the nanowire junction at the current time:

$$\frac{d w}{d t} = f ( w , v )$$

For a certain class of nanowire junctions, modeled by a single state variable w that represents the conductivity of the memristive material, the rate of change of the state variable, or conductivity, with time can be approximated as:

$$\frac{d w}{d t} = Kw sinh Mv$$

where K and M are constants, for a range of values of |w| from 0 to a maximum value wₘₐₓ. Outside of this range,

$$\frac{d w}{d t}$$

is assumed to be 0. FIG. 11B shows a plot of this expression. The solid curve 1108 in FIG. 11B shows a plot of the above expression for particular, assumed values of K and M. The rate of change of conductivity with time may also follow the mirror-image curve 1110, plotted in dashes in FIG. 11B, in different types of junction materials, or it may vary by other, more complex non-linear functions. However, in general, the memristive behavior of nanowire junctions is such that the change in conductance is decidedly non-linear with respect to applied voltage. Small applied voltages of either positive or negative polarity across the junction, in the range of small voltages 1116 about the voltage 0, do not produce, significant change in the conductivity of the junction material, but outside this range, increasingly large applied voltages of positive polarity result in increasingly large rates of increase in the conductivity of the junction material, while increasingly large voltages of negative polarity result in steep decreases in the rate of change of conductivity of the junction material. The conductance of the nanowire-junction device is proportional to the conductivity of the junction material.

It should be emphasized that the above-described model for the change in conductance of a memristive nanowire junction represents only one possible type of relationship between memristive-nanowire junction conductance and applied voltage. The computational nodes and computational-node-network implementations that represent embodiments of the present invention do not depend on the relationship between conductance and applied voltage to correspond to the above-described mathematical model, but only that the change in conductance elicited by application of 1 V across the junction for a given period of time t is substantially less than the change in conductance elicited by application of 2 V across the junction for the same time t, and that the conductance change elicited by applied voltages of a first polarity have an opposite sign, or direction, than applied voltages of a second polarity. The relationship need not have mirror symmetry, as docs the model relationship described above, since the time t can be adjusted for different polarities in order to achieve a desired edge-weighting model.

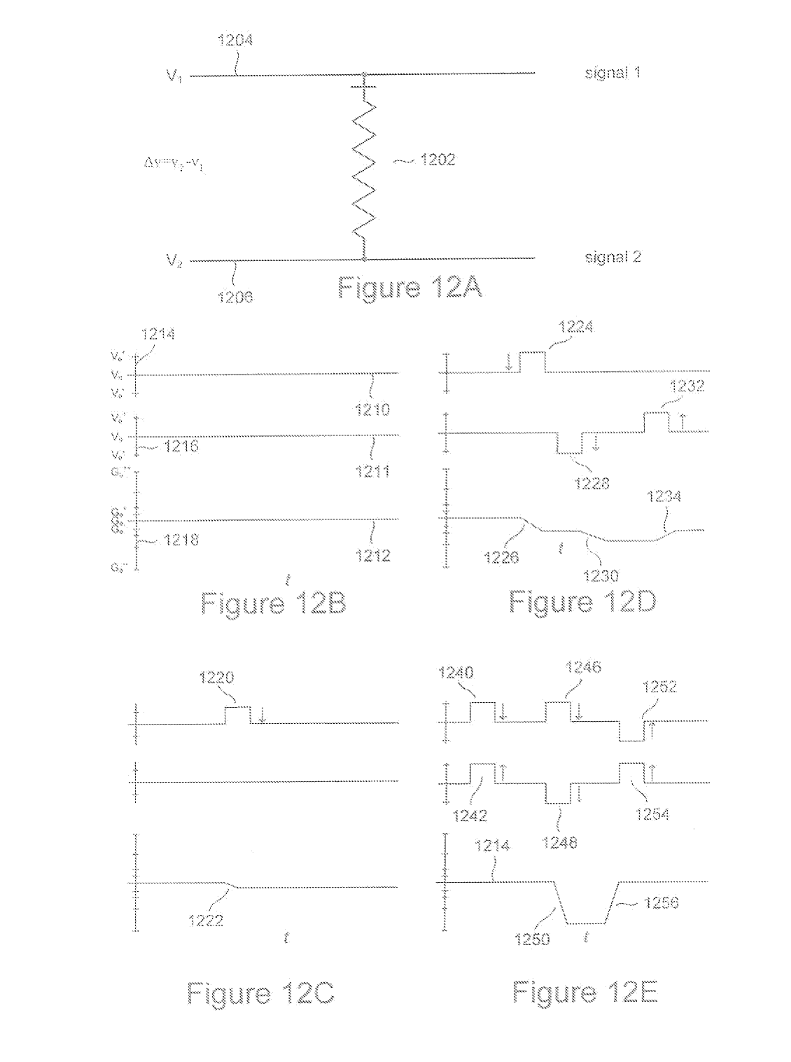

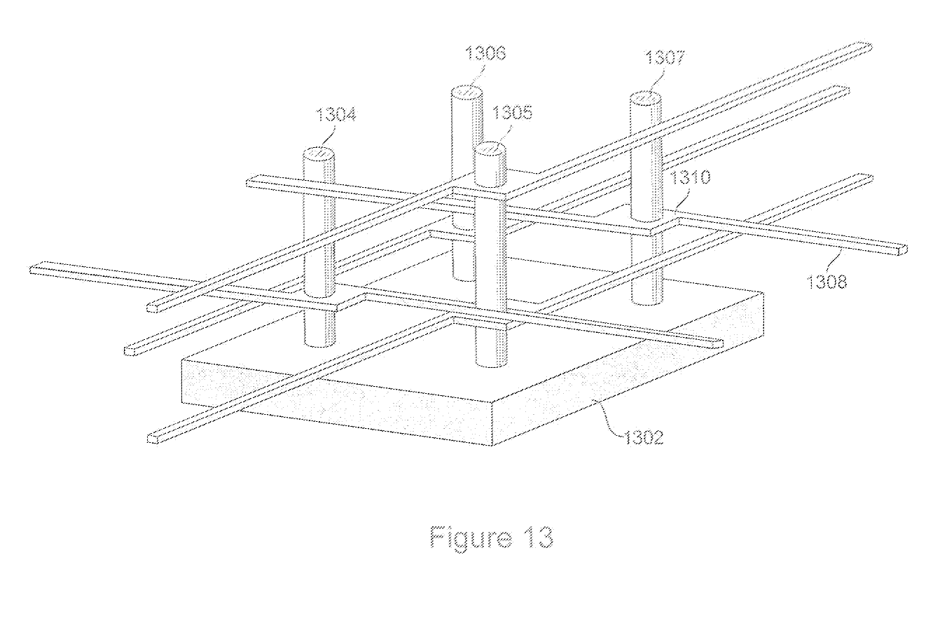

FIGS. 12A-E illustrate memristive, nanowire-junction conductance, over time, with respect, to voltage signals applied to two signal lines that are connected by a memristive, nanowire junction. FIG. 12A shows the memristive nanowire junction in symbolic terms. The memristive nanowire junction 1202 interconnects a first signal line 1204 with a signal line 1206, referred to as “signal line 1” and “signal line 2,” respectively. The voltage applied to the memrister 1202, Δv, is v₂−v₁, where v₂ and v₁ are the voltage signals currently applied to signal line 2 and signal line 1, respectively. FIG. 12B shows a plot of the voltage signals applied to signal lines 1 and 2, and the conductance of the memristive device, over a time interval. Time is plotted along a horizontal direction for signal line 1, signal line 2, and the memristive device. The voltage signal currently applied to signal line 1 is plotted with respect to a vertical axis 1214, the voltage currently applied to signal line 2 is plotted with respect to a second vertical axis 1216, and the conductance of the memristive device is plotted with respect to a third vertical axis 1218. FIGS. 12C-E all use illustration conventions similar to those used in FIG. 12B.

As shown in FIG. 12B, when a constant voltage v₀ is applied to both signal lines, represented by horizontal lines 1210 and 1211, the conductance of the memristive device remains at an initial conductance G₀ 112. In FIG. 12C, a short, positive voltage pulse 1220 is applied to the first signal line. That short pulse generates a brief negative potential across the memristive junction, resulting in a decrease 1222 in the conductance of the memristive junction over the time interval of the positive pulse. FIG. 12D illustrates effects of several pulses applied to both signal lines 1 and 2. A first pulse 1224 applied to signal line 1 results, as in FIG. 12C, with a small decrease in conductance of the memristive device 1226. A brief negative-voltage pulse 1228 applied to the second signal line causes an additional small decrease in conductance of the memrister 1230. A brief positive pulse applied to the second signal line results in a small increase in the conductance of the memristive device 1234.

In all of the cases so far illustrated, the pulses applied to the first and second lines are separated from one another in time, so that voltage pulses on both signal lines do not occur at the same point in time. Thus, the small applied voltages fall within the range of voltages (1116 in FIG. 11B) that results in only small rates of conductivity change in the memristive-device material. However, as shown in FIG. 12E, when voltages of opposite polarity are simultaneously applied to the two signal lines, the resulting voltage applied across the memrister falls outside of the small-voltage range (1116 in FIG. 11B), resulting, in relatively large rates of conductivity change. In FIG. 12E, two simultaneous voltage pulses 1240 and 1242 of positive polarity result in no change in the voltage applied to the memristive junction, and therefore result in no change to the conductance of the memristive device 1244. However, a simultaneously applied positive pulse 1246 on the first signal line and negative pulse 1248 on the second signal line result in a relatively large applied voltage of negative polarity to the memristive device, resulting in a large negative change in the conductance of the device 1250. By contrast, simultaneous pulses of reversed polarities 1252 and 1254 result in a relatively large increase in conductance of the device 1256. Were the conductivity/voltage curves of the memristive-device material to have the opposite conductivity-change behavior, represented by dashed curve in FIG. 11B, or were the direction of the voltage convention for computing Δv reversed, the conductance changes in FIGS. 12B-E would have opposite directions from those shown.

In summary, memristive nanowire junctions, and other nanoscale features fabricated from memristive materials, show non-linear conductance changes as a result of applied voltages. The conductance of a memristive nanowire junction reflects the history of previously applied voltages, and the rate of change of the conductance at a given instance in time of a memristive nanowire junction depends on the magnitude and polarity of the applied voltage at that instance in time, in addition to the conductance of the memristive nanowire junction. Memristive nanowire junctions have polarities, with the signs of conductance changes reflective of the polarities of applied voltages. A memristive nanowire junction thus has physical characteristics that correspond to the model characteristics of the dynamical edges of a neural network, perceptron network, or other such network of computational entities.

### A Proposed Neuromorphic Architecture

Recently, an architecture for high-neuron-density neuromorphic integrated circuits has been proposed in which synapses are implemented as memristive junctions between nanowires or as other nanoscale features fabricated from memristive materials. The nanowire signal lines mimic dendrites and axons of biological neurocircuitry and are fabricated within nanowire interconnection layers above the semiconductor-integrated-circuit layer, thus preserving the semiconductor-integrated-circuit surface for implementation of neuron computational cells, referred to as “neural cells” in the following discussion, and multi-computational-cell modules. Thus, hybrid microscale-nanoscale neuromorphic integrated circuits may employ memristive nanowire junctions, rather than digital logic or analog circuitry, to implement synapses, and synapses and synapse-based interconnections between neural cells are implemented within nanowire interconnection layers above the semiconductor-integrated-circuit layer, providing vastly greater neural-cell density in a three-dimensional hybrid microscale-nanoscale neuromorphic-circuit architecture.

FIG. 13 shows a basic computational cell of a hybrid microscale-nanoscale neuromorphic integrated circuit. The computational cell includes a regular area of a semiconductor-integrated-circuit layer 1302 from which four conductive pins 1304-1307 extend vertically. Horizontal nanowires, such as nanowire 1308 in FIG. 13, interconnect to the conductive pins through pad-like structures, such as pad-like structure 1310, and extend linearly across a number of computational cells within a neighborhood of computational cell 1302 in a two-dimensional array of computational cells of a hybrid microscale-nanoscale neuromorphic integrated circuit. As discussed further, below, the semiconductor-integrated-circuit layer of the computational cell 1302 includes various interconnections and analog components that implement a model of a neuron or other fundamental computational device, certain of which are described below in greater detail. The four vertical pins 1304-1307 serve to interconnect the analog components and circuitry within the semiconductor-integrated-circuit-layer portion of the computational cell 1302 to layers of nanowires, such as nanowire 1308. The nanowires, in turn, may interconnect the computational cell to neighboring computational cells through nanowires and memristive junctions that model synapses.

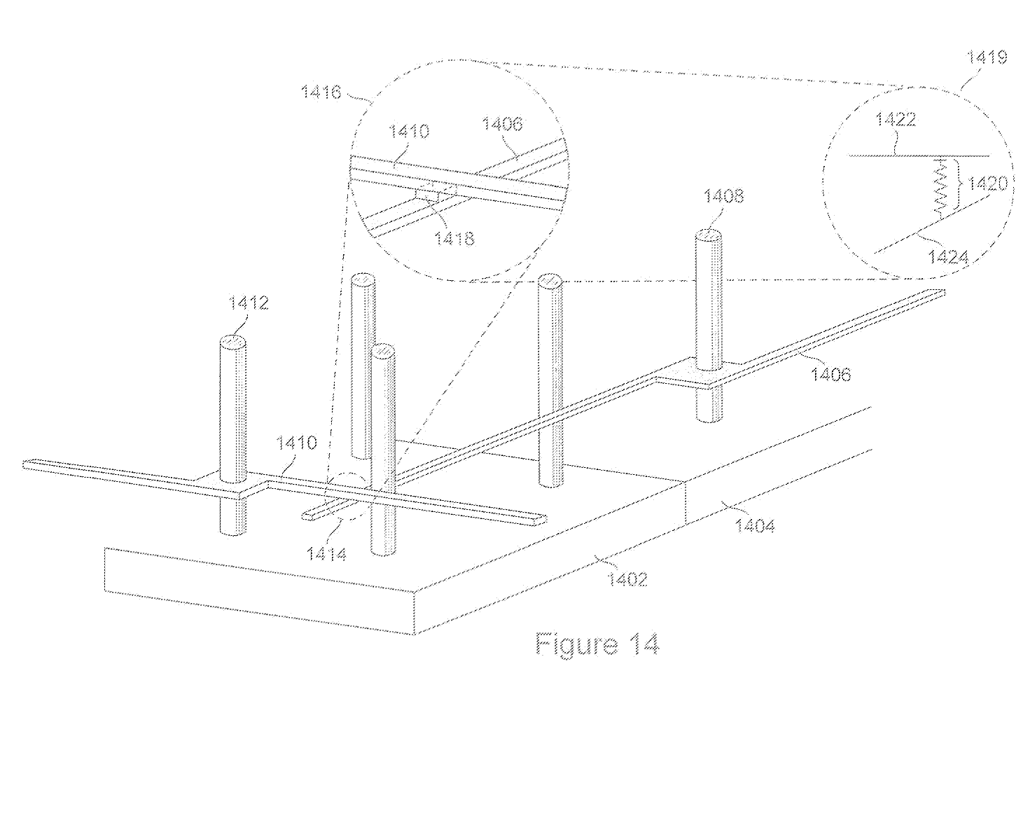

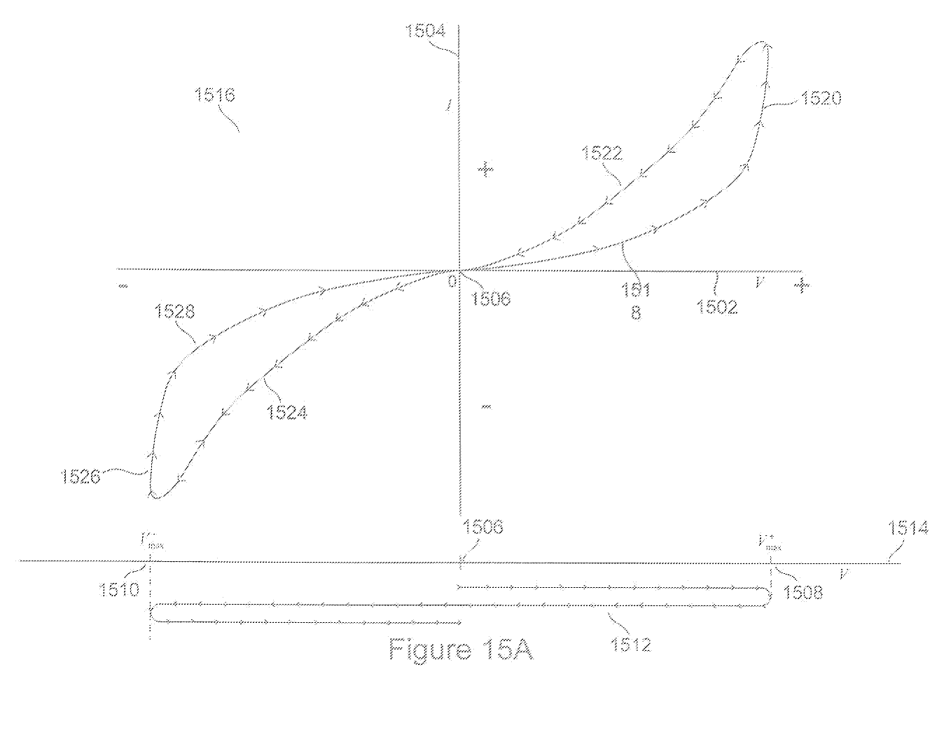

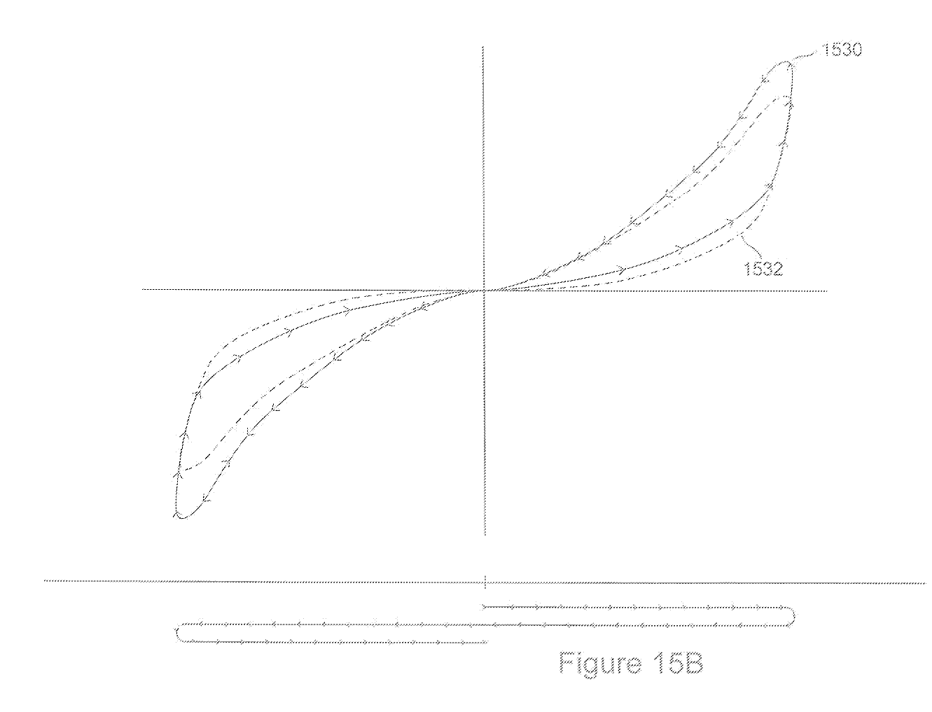

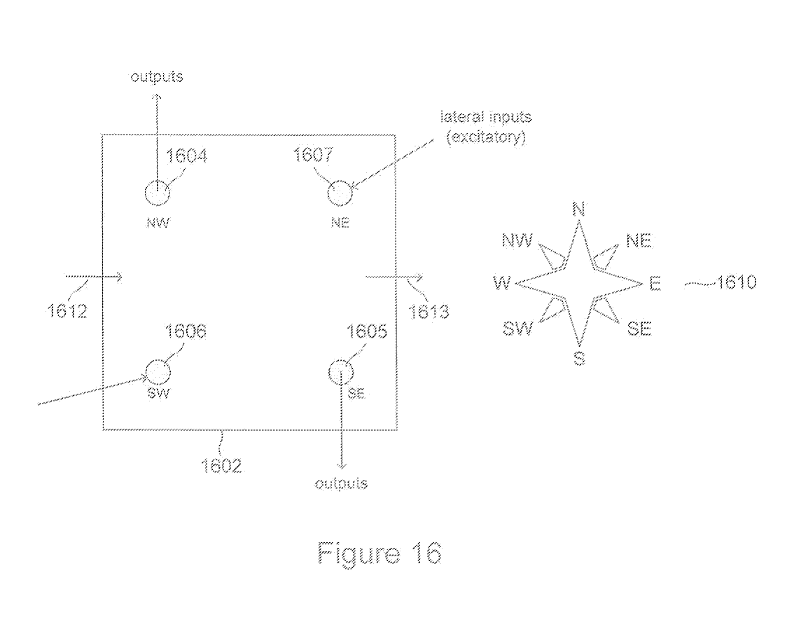

FIG. 14 illustrates a memristive junction between two nanowires that models synapse behavior. In FIG. 14, a first computational cell 1402 is shown to be positioned adjacently to a neighboring computational cell 1404. A first nanowire 1406 is connected to a vertical pin 1408 of the adjacent, neighboring computational cell 1404. A second nanowire 1410 is electronically connected to a vertical pin 1412 of computational cell 1402, shown in the foreground of FIG. 14. The first nanowire 1406 and second nanowire 1410 overlap one another in the region demarcated by the small dashed circle 1414 in FIG. 14, the overlap region magnified in the inset 1416. There is a small layer of memristic material 1418 lying between the first nanowire 1406 and second nanowire 1410 that electronically interconnects the first nanowire with the second nanowire. The memristic junction between the two nanowires can be symbolically represented, as shown in inset 1419, by a memristor symbol 1420 interconnecting two signal lines 1422 and 1424. As discussed further, below, each nanowire in an interconnection layer may interconnect with many different nanowires through memristive junctions.

FIGS. 15A-B illustrate the essential electronic properties of memristive junctions employed to model synapses. Both FIGS. 15A and 1513 show current/voltage plots for a memristive junction. Voltage is plotted with respect to a horizontal axis 1502 and current is plotted with respect to a vertical axis 1504. A voltage sweep is illustrated in FIG. 15A. The continuous voltage changes that comprise the voltage sweep are represented by the voltage path 1512 plotted with respect to a second voltage axis 1514 in register with, and below, the current/voltage plot 1516 in FIG. 15A. As shown in FIG. 15A, a voltage sweep is carried out by steadily increasing voltage from a voltage of zero 1506 to a voltage Vₘₐₓ⁺ 1508, by then decreasing the voltage continuously to a negative voltage Vₘₐₓ⁻ 1510, and by then increasing the voltage back to 0 (1506 in FIG. 15A). The current/voltage plot illustrates how the conductivity of the memristive material changes during the voltage sweep.

Initially, the memristive material is in a low conductivity state, so that the current remains relatively low, in magnitude, in a first portion of the plot 1518 as voltage is increased from 0 (1506 in FIG. 15A) to just below Vₘₐₓ⁺ 1508. Near Vₘₐₓ⁺, the current begins to rapidly rise 1520 as the resistance of the memristive material dramatically falls, or the conductivity increases, in a non-linear fashion. As the voltage is then decreased from Vₘₐₓ⁺ down to Vₘₐₓ⁻ 1510, the conductivity of the memristive material remains high, as can be seen from the currents of relatively large magnitude passed by the memristive material for corresponding voltage values in portions of the plot 1522 and 1524. Near the negative voltage Vₘₐₓ⁻, the conductance of the memristive material suddenly begins to decrease steeply 1526. The memristive material is placed into a low conductance state, at Vₘₐₓ⁻, that is retained as the voltage is again increased towards 0 (1528 in FIG. 15A). As shown in FIG. 15B, a second voltage sweep 1530 increases the conductance of the memristive material with respect to the conductance generated during the first voltage sweep, indicated by dashed lines 1532. Additional voltage sweeps may further increase the conductance of the memristive material with respect to the conductance generated during the previous voltage sweep. Thus, the memristive material exhibits non-linearity in conductance under continuously increasing or decreasing applied voltage, and additionally exhibits a memory of previous conductance states. In other words, for various types of memristive materials, the physical state of the memristive material w changes, with respect to time, as a function both of the current physical state of the memristive material and the applied voltage:

$$\frac{d w}{d t} = f ( w , V ) .$$

The current i passed by a memristive junction is a function of the applied voltage and conductance of the material, where the conductance g is a function both of the current state of the memristive material and the applied voltage:

i=g(w,v)V.

As shown in FIGS. 15A-B, the conductance of the memristive junction depends on the currently applied voltage as well as on the history of applied voltages over a preceding time interval.

A synapse generally produces amplification or attenuation of a signal produced by a pre-synaptic neuron i and directed through the synapse to a post-synaptic neuron j. In certain models, the gain, or weight, of a synapse ranges from 0.0 to 1.0, with the gain 0.0 representing full attenuation of the signal and the gain 1.0 representing no attenuation of the signal. In these models, neurons have activities, and when the activity of a neuron i, xᵢ, is greater than a threshold value, the neuron emits an output signal. The mathematical model for neuron behavior is provided in a subsequent paragraph. One mathematical model for the rate of change of gain zᵢⱼ for a synapse that interconnects a pre-synaptic neuron i with a post-synaptic neuron j is expressed as:

$$\frac{d {z}_{ij}}{d t} = ɛ f ( ( {x}_{j} ) ( - {ωz}_{ij} + g ( {x}_{i} ) ) )$$

where
zᵢⱼ is the weight of, or gain produced by, the synapse ij interconnecting pre-synaptic neuron i with post-synaptic neuron j;
ε is a learning rate;
ω is a forgetting rate;
ƒ(xⱼ) is non-linear function of the activity of neuron i;
g(xᵢ) is non-linear function of the activity of neuron j; and
t is time.

In many cases, ƒ( ) and g( ) are generally sigmoidal. One exemplary sigmoidal, or “S” shaped, function is tan h( ). When the pre-synaptic neuron and post-synaptic neuron both have high activities, the gain zᵢⱼ rapidly increases. The term −ωzᵢⱼ ensures that the gain of a synapse decreases, over time, when the term −ωzᵢⱼ has a magnitude greater than the current values of the non-linear function of the activity of the post-synaptic neuron g(xᵢ). The weight of a synapse cannot increase or decrease in unbounded fashion, due to feedback term −ωzᵢⱼ, which acts to decrease the weight of the synapse as the synapse weight of the synapse approaches 1.0; and which produces less and less feedback as the weight of the synapse approaches 0.0. The mathematical model for synapse behavior depends on the mathematical model for neuron activity, and the models provide mutual feedback to one another. As can be seen by comparing the mathematical model for synapse gain to the above expressions describing conductivity changes of a memristive junction, in particular, the conductance function g(w, v), the conductance of a memristive junction may provide a physical embodiment of a gain function, the time derivative of which is expressed as the above mathematical model, since the non-linear functions of neuron activities ƒ(xᵢ) and g(xᵢ) of the synapse model are related to the to physical voltage between neurons and the gain, zᵢⱼ, at a given point in time is related to the history of voltages applied to the memristive junction. The functional expression for conductance of a memristive nanowire junction thus depends on the current activities of pre-synaptic and post-synaptic neurons connected by the memristive nanowire junction as well as the recent applied-voltage history of the memristive nanowire junction. Thus, memristive nanowire junctions interconnecting nanowires provide physical characteristics for passing current signals suitable for modeling synapse behavior as expressed by the above mathematical model.

FIG. 16 shows a neural cell that serves as a basic computational unit in various embodiments of a hybrid microscale-nanoscale neuromorphic integrated circuit. A neural cell is one type computational cell within a hybrid microscale-nanoscale neuromorphic integrated circuit. As discussed above, the neural cell 1602 includes four vertical-conductive pins 1604-1607. The pins are referred to by their compass directions, with a compass diagram 1610 shown to the right of the computational cell in FIG. 16. The NW pin 1604 and SE pin 1605 conduct output signals from the neural cell to nanowires interconnected with NW pin 1604 and SE pin 1605. The SW pin 1606 and the NE pin 1607 both conduct signals, input to the pins from nanowires connected to the pins, to the neural cell 1602. The SW pin 1606 conducts inhibitory signals into the neural cell, while the NE pin 1607 conducts excitatory input signals into the neural cell. Excitatory input signals tend to increase the activity of a neural cell, while inhibitory signals tend to decrease the activity of a neural cell.

The basic neural cell 1602 shown in FIG. 16 generally implements one of numerous different mathematical models for a neuron. In general, when the frequency and number of received excitatory signal significantly exceeds the frequency and number of inhibitory signals, the activity of a neuron generally increases above a threshold activity value, at which point the neuron emits output signals through output pins 1604 and 1605.

The input excitatory signals and input inhibitory signals are received through synapse-like memristive nanowire junctions from other neural cells of a hybrid microscale-nanoscale neuromorphic integrated circuit, and output signals emitted by the neural cell 1602 are directed through synapse-like memristive nanowire junctions to other computational cells of a hybrid microscale-nanoscale neuromorphic integrated circuit. Neural cells and neuromorphic circuits generally include various feedback mechanisms and exhibit non-linear behavior that control and constrain the activities of individual neural cells within a neuromorphic circuit. Even modestly-size neuromorphic circuits containing only a relatively small number of neural cells densely interconnected through synapses can exhibit quite complex functionality that often cannot be modeled using closed-form mathematical expressions and that would be difficult to implement in traditional Boolean-logic-based digital logic circuits. In FIG. 16, input 1612 and output 1612 indicate that, in addition to receiving signals and transmitting signals through the four vertical pins, a neural cell can all interconnect with adjacent computational cells through additional microscale or submicroscale signal lines implemented within the semiconductor-integrated-circuit level of a hybrid microscale-nanoscale neuromorphic integrated circuit.

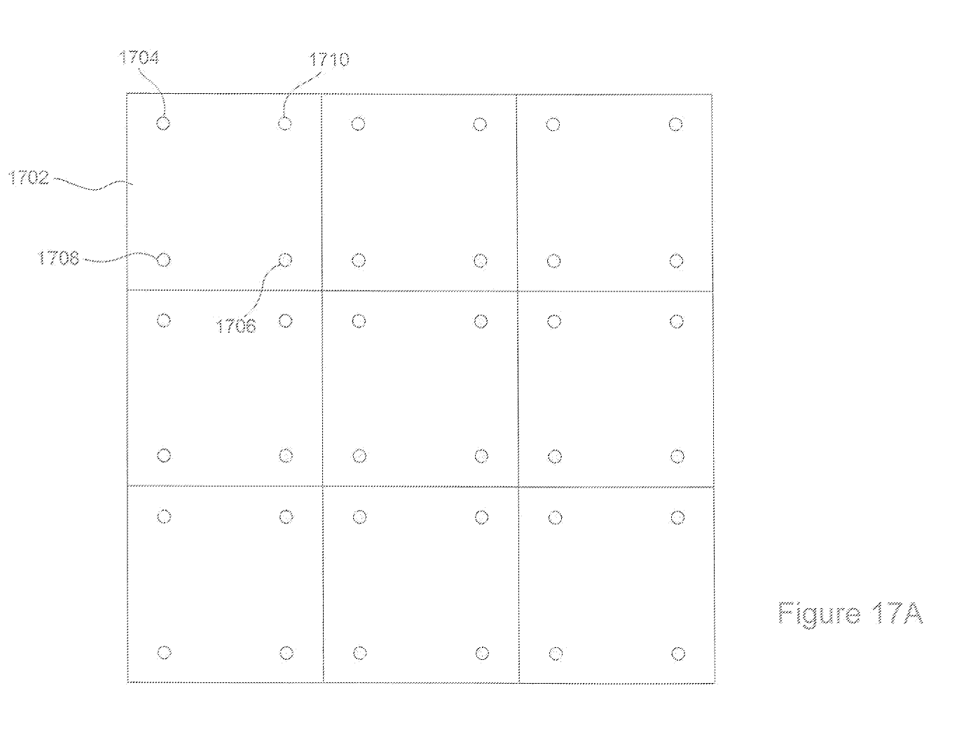

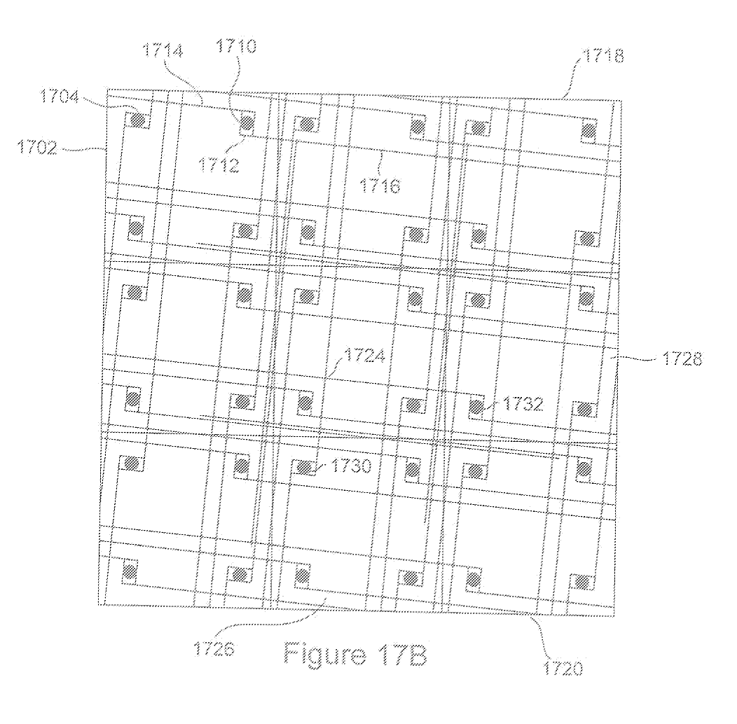

FIGS. 17A-B illustrate interconnection of computational cells within a hybrid microscale-nanoscale neuromorphic integrated circuit. FIG. 17A shows a 3×3 array of 4-pin computational cells. As discussed above, each computational cell, such as computational cell 1702, includes two output pins 1704 and 1706, an inhibitory input pin 1708, and an excitatory input pin 1710. FIG. 17B shows the 3×3 array of computational cells, as shown in FIG. 17A, above which an interconnection layer, comprising two sublayers of parallel nanowires and a memristive-material sublayer, has been implemented. In FIG. 17B, each input pin, such as input pin 1710 of computational cell 1702, interfaces to a pad 1712 that joins a left-hand approximately horizontal nanowire 1714 to a right-hand, approximately horizontal nanowire 1716 and joins both the left-hand and right-hand nanowires 1714 and 1716 to the input pin 1712. Thus, all of the nanowires connected to input pins in the array of computational cells form a first sublayer of parallel nanowires. As shown in FIG. 17B, the nanowires are slightly rotated with respect to the direction of the upper 1718 and lower 1720 horizontal edges of the 3×3 array of computational cells. This rotation allows nanowires to extend horizontally in both leftward and rightward directions, and span many neighboring computational cells without overlying any additional vertical pins within, or external to, the computational cell to which the nanowires are connected via a pad and vertical pin. The output pins, such as output pin 1704 in computational cell 1702, are each similarly connected to an approximately vertical nanowire. Thus, the nanowires connected to output pins in the 3×3 array of computational cells form a second sublayer of approximately parallel nanowires, with the nanowires of the second sublayer approximately orthogonal to the nanowires of the first sublayer.

In FIG. 17B, memristive nanowire junctions between nanowires are shown as small filled disks, such as filled disk 1724, at the intersection between two nanowires. Memristive nanowire junction 1724 models a synapse interconnecting pre-synaptic neural cell 1726 and post-synaptic neural cell 1728. Memristive nanowire junction 1724 interconnects the output pin 1730 of pre-synaptic computational cell 1726 with the inhibitory input pin 1732 of post-synaptic neural cell 1728. Multiple nanowire-interconnection layers may be implemented above the semiconductor-integrated-circuit-layer of a hybrid microscale-nanoscale neuromorphic integrated circuit. Multiple interconnection layers allow neural cells to be interconnected with one another through synapse-like memristive nanowire junctions at multiple, hierarchical, logical levels. The multiple-interconnection-layer neuromorphic-integrated-circuit architecture provides for an extremely large number of different possible interconnection configurations of computational cells, and thus provides an extremely flexible and powerful interconnection architecture for implementing a very large number of different possible neuromorphic circuits.

In certain hybrid microscale-nanoscale neuromorphic-integrated-circuits, nanowire junctions may be configured during manufacture, or may be subsequently programmed, to be in ON and OFF states, with only those nanowire junctions configured to be ON passing current and exhibiting synapse-like behavior, while the nanowire junctions configured to be OFF act as open switches. In other hybrid microscale-nanoscale neuromorphic-integrated-circuits, the nanowire junctions are all configured to be in the ON state, and the conductance of each nanowire-junction is determined exclusively by the voltage signals passing through it.

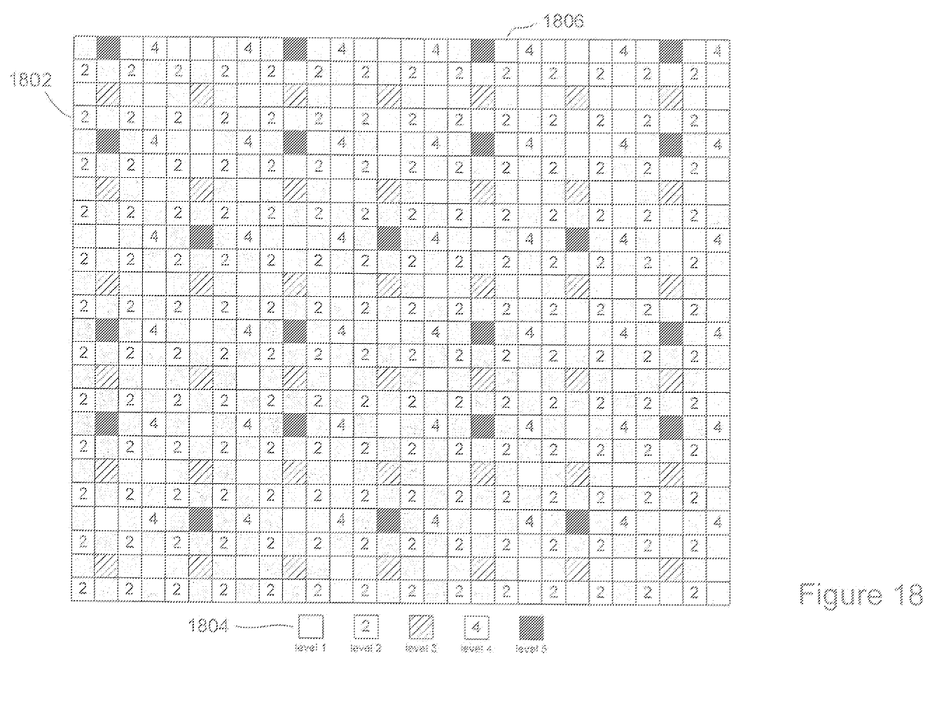

FIG. 18 illustrates hierarchical interconnection of computational cells within a hybrid microscale-nanoscale neuromorphic integrated circuit. FIG. 18 shows a 24×28 array of computational cells 1802. Each cell is assigned to a logical level according to the logical-level key 1804 provided below the array. For example, the shaded computational cells, such as shaded computational cell 1806, form a first logical level. Such hierarchical logical arrangements of computational cells can be implemented by using one nanowire-interconnect layer to interconnect neural cells of each level. For example, the first-level computational cells may be laterally interconnected by nanowires and memristive nanowire junctions within a first nanowire-interconnect layer. Second-logical-level cells may be similarly interconnected by a second nanowire-interconnect layer. In addition, forward and feedback interconnections and may traverse multiple interconnection levels and thus provide for exchange of signals between logical levels. Hierarchically ordered layers of computational cells are useful in various types of pattern-recognition neuromorphic circuits and inference engines that draw inferences from multiple inputs.

### Method and System Embodiments of the Present Invention

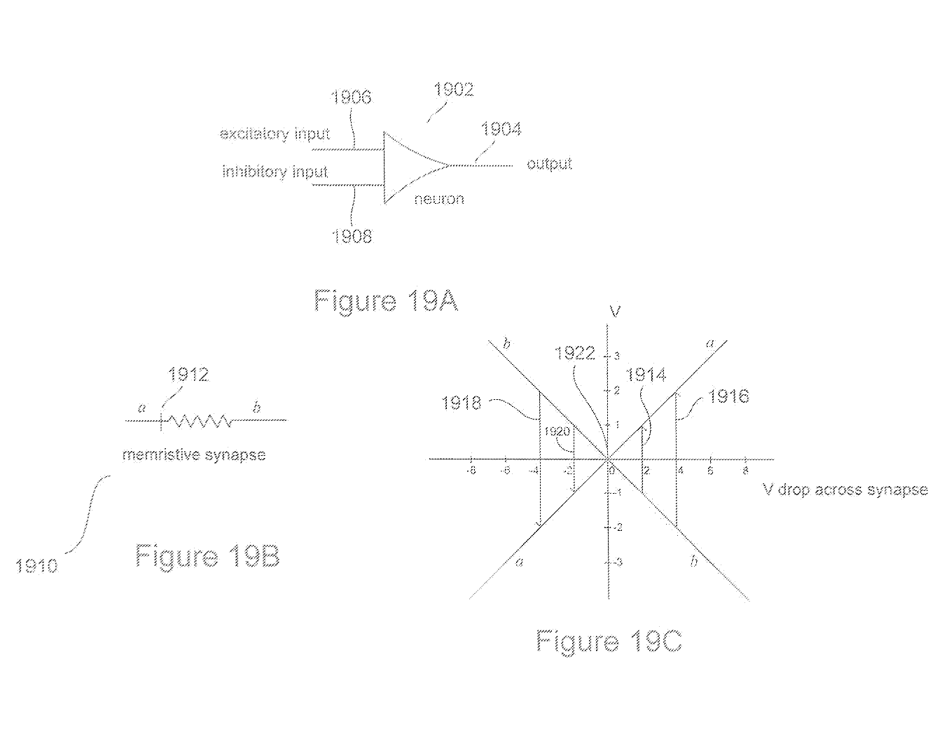

As discussed above, the method and system embodiments of the current invention are directed to machine learning through controlled and deterministic changes in the physical characteristics of synapse-like junctions through which neuron processing units of a neuromorphic circuit are interconnected. For purposes of describing and illustrating certain method and system embodiments of the present invention, various illustration conventions are used. FIGS. 19A-C illustrate several of the illustration conventions used in subsequent figures. First, as shown in FIG. 19, a neuron, or neuron processing unit, of a neuromorphic circuit is represented, in subsequent drawings, by the symbol 1902 shown in FIG. 19A. The neuron produces a single output 1904 and receives a single excitatory input 1906 and a single inhibitory input 1908. Of course, neurons may be implemented to produce two or more outputs, to receive only an excitatory or inhibitory input, or to receive two or more excitatory inputs and/or two or more inhibitory inputs. However, in the following discussion, a simple neuron, symbolized by the symbol shown in FIG. 19A, is the basis for the neuromorphic circuits employed to illustrate various embodiments of the present invention.

In the exemplary neuromorphic circuits, used to illustrate various embodiments of the present invention, synapses are fashioned from memristive materials, and represented by the symbol 1910 shown in FIG. 19B. FIG. 19C illustrates, in a voltage/voltage-drop graph, the voltage-related conventions associated with the memristive-synapse symbol 1910 in FIG. 19B. The memristive synapse is asymmetrical, having one end, labeled “a” in FIG. 19B, having a vertical-bar 1912 portion of the symbol, and an opposite end, labeled “b” in FIG. 19B, without a vertical-bar portion. When the voltage applied to the end labeled “a” is greater, or more positive, than the voltage applied to the end labeled “b,” as in the portion of the graph shown in FIG. 19C to the right of the vertical axis, the voltage drop across the memristive synapse is considered to be positive, illustrated in FIG. 19C by the two positive voltage drops 1914 and 1916 represented by upward directed arrows. Conversely, when the voltage applied to the end labeled “b” is greater, or more positive, than the voltage applied to the end labeled “a,” the voltage drop across the memristive synapse is considered to be negative, illustrated in FIG. 19C by the two downward-directed arrows 1918 and 1920. FIG. 19C shows a special case in which the voltages applied to the two ends of the memristive synapse have opposite signs except at the origin 1922, but the voltage-drop sign convention applies for any difference in the voltages applied to the ends of the memristive synapse.

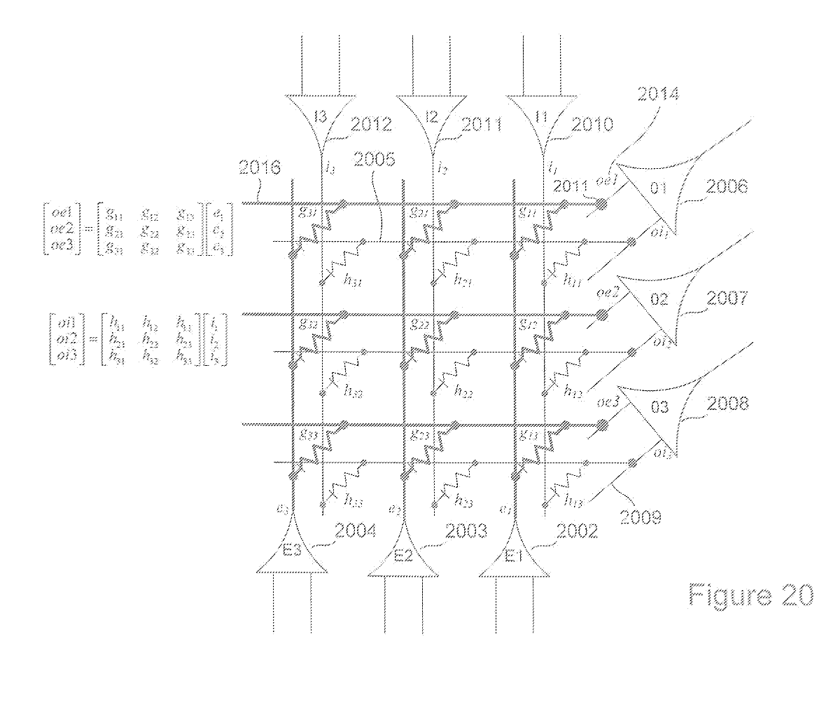

FIG. 20 illustrates a small portion of an exemplary neuromorphic circuit. In the exemplary circuit shown in FIG. 20, three neurons 2002-2004, referred to as “E1,” “E2,” and “E3,” respectively, in a first nanowire-crossbar layer shown in fine lines, such as line 2005, output signals to the excitatory inputs of three neurons 2006-2008, referred to as “O1,” “O2,” and “O3,” respectively, in a second nanowire-crossbar layer, only a small portion of which is shown in FIG. 20 as diagonal lines, such as diagonal line 2009. Three neurons 2010-2012, referred to “I1,” “I2,” and “I3,” respectively, in a third nanowire-crossbar layer, shown in heavy lines, such as heavy line 2010, output signals to the inhibitory inputs of neurons O1, O2, and O3. Note that the filled disks, such as filled disk 2011, indicate vias or pins roughly orthogonal to the plane of the figure, providing inter-nanowire-crossbar-layer connections. Each input, whether excitatory or inhibitory, of the neurons O1, O2, and O3 receive signals that represent the sum of signals output by either neurons E1, E2, and E3 or by neurons I1, I2, and I3. For example, the excitatory input of neuron O1 2014 receives an excitatory signal oe1 that is a combination of the signals e₁, e₂, and e₃ output by neurons E1, E2, and E3. The signal lines output from nodes E1, E2, and E3 are interconnected with the excitatory input to neuron O1 2014 by three memristive synapses g₁₁, g₂₁ and g₃₁, respectively. Thus, the total signal input to the excitatory input 2014 of neuron O1 is the sum: oe1=e1g₁₁+e2g₁₂+e3g₁₃. The excitatory and inhibitory inputs for the three neurons O1, O2, and O3 can thus be computed by the matrix equations:

$$[ \begin{matrix}oe 1 \\ oe 2 \\ oe 3\end{matrix} ] = [ \begin{matrix}{g}_{11} & {g}_{12} & {g}_{13} \\ {g}_{21} & {g}_{22} & {g}_{23} \\ {g}_{31} & {g}_{32} & {g}_{33}\end{matrix} ] [ \begin{matrix}{e}_{1} \\ {e}_{2} \\ {e}_{3}\end{matrix} ] \\ [ \begin{matrix}oi 1 \\ oi 2 \\ oi 3\end{matrix} ] = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] [ \begin{matrix}{i}_{1} \\ {i}_{2} \\ {i}_{3}\end{matrix} ]$$

In certain embodiments of the present invention, as expressed in the above equations, given that the gᵢⱼ refer to the conductances of the memristive junctions, output signals are voltage pulses which, after passing through synapses, the signals may be viewed as current signals at inputs to downstream neurons. In one embodiment of the present invention, current signals are transformed back to voltage signals at neuron inputs, as discussed below.

Regardless of whether signals are considered to be voltage or current signals, it can be appreciated, from FIG. 20, that the inputs to the output neurons O1, O2, and O3 for the neuromorphic circuit depend both on the signals output from the input nodes E1, E2, and E3 and I1, I2, and I3 and on the physical characteristics gᵢⱼ of each synapse-like junction interconnecting signal lines output from the input nodes and the input signal lines to the output neurons. In the currently discussed exemplary neuromorphic circuit, the gᵢⱼ refer to the conductances of the memristive junctions. However, other physical characteristics of a synapse-like junction may be considered as modifying signal propagation through the synapse-like junction, in alternative embodiments. The conductances of memristive synapse-like junctions, in the currently discussed circuit, and, in a more general case, the physical characteristics of the synapses, represent a memory within the neuromorphic circuit, the current state of which influences output of the neuromorphic circuit, just as the memory within an organism influences how the organism reacts to sensory input.

In certain, previously proposed neuromorphic-circuit implementations, the neurons are entirely analog devices, and are not synchronized with one another in time. In these implementations, conductances of the memristive junctions are modified by forward and back propagation of signals through synapses in an asynchronous fashion. Such neuromorphic circuits can exhibit learning according to the spike-timing-dependent-plasticity (“STDP”) learning model, and other learning models, but are heavily constrained by the physical characteristics of the memristive junctions and, due to the continuous signals propagated through nanoscale junctions, dissipate large amounts of power and produce relatively large amounts of heat, as a result.

In order to address problems associated with the asynchronous neuromorphic-circuit models, discussed above, method and system embodiments of the present invention employ clock-based synchronization of neurons within a neuromorphic circuit in order to coordinate signal propagation through the neuromorphic circuit and to therefore provide controlled and deterministic alteration of the physical characteristics of synapse-like junctions using timed, relatively short-duration voltage-pulse signals rather than continuous signals. The method and system embodiments of the present invention remove many of the constraints of the previously proposed analog neuromorphic circuits, so that any of various different learning models can be implemented, and power dissipation can be controlled to acceptable levels. According to embodiments of the present invention, it is even possible to implement different learning models in different portions of a single neuromorphic circuit, when desired.

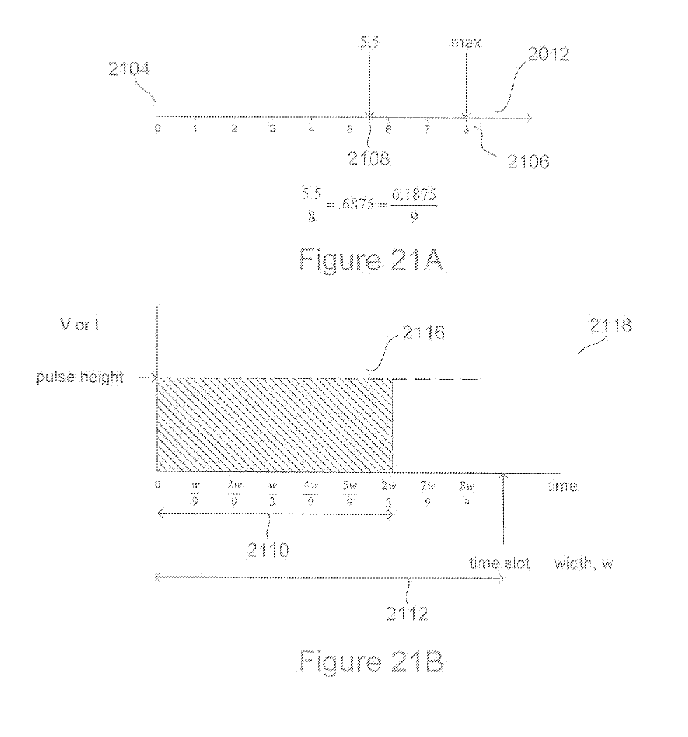

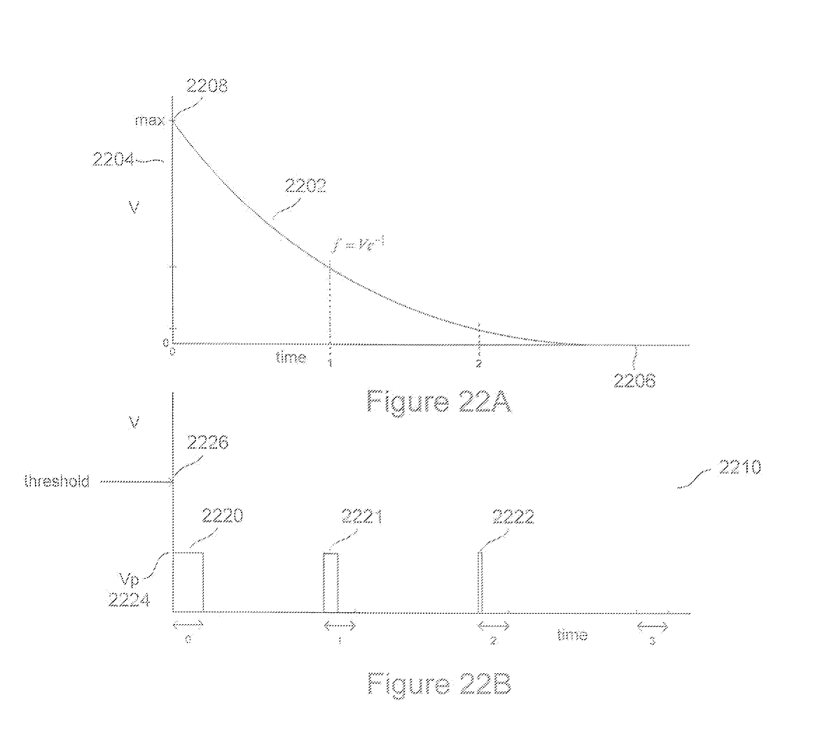

Certain embodiments of the present invention employ pulse-width modulation (“PWM”) for encoding and transmitting numeric values. FIGS. 21A-22B illustrate pulse-width-modulation-based representation of an exponential-decay function. FIG. 21A shows a portion of the positive real number line and a particular numerical value within the portion of the line segment, or range of real numbers represented by the portion of the line segment. The portion of the positive real number line 2102 includes a continuous line segment from the origin 2104 to a maximum value 2106 of 8.0. Consider the real number 5.5 (2108 in FIG. 21A). The real number 5.5 can be represented as the alphanumeric character string “5.5” or as the Coating-point value 5.5, but encoding and transmitting alphanumeric character strings and floating-point values would require far more complex encoding and decoding algorithms than are desirable to implement in the neuromorphic circuits to which embodiments of the present invention are directed, and employing such encoding would general be computationally inefficient. Moreover, method and system embodiments of the present invention depend on a fairly direct encoding of numeric values into voltage or current signals that can impart characteristics to memristive junctions proportional to, or otherwise related to, a numeric value being transmitted. One method for direct encoding of the real-number value 5.5 is to use a constant-voltage pulse of a certain, first duration within a time slot, or period of time, of a second duration, where the ratio of the first and second duration is equal to 5.5/8, or 0.6875, the ratio of the number to be encoded, 5.5, to the maximum number within a range of numbers that can be encoded. Thus, as shown in the graph 2118 of FIG. 21B, transmitting a voltage pulse 2116 of duration 2110 within a time slot of duration 2112 encodes the ratio 0.6875, or 5.5/8. Thus, the number 5.5 can be obtained, by an entity receiving the voltage pulse, by multiplication of 8.0, the maximum real number that can be represented by the voltage pulse, by the ratio of the duration of the voltage pulse 2116 to the duration 2112 of the fixed-length time slot.

FIG. 22A shows a plot of an exponential-decay function 2202, with voltage represented by a vertical axis 2204 and time represented by the horizontal axis 2206. An exponential voltage decay function can be represented as:

ƒ(t)=Ve^{t/τ}

where

V is the maximum voltage (2208 in FIG. 22A);

t is time; and

τ is a time constant.

This function can be transformed to discrete values and transmitted as a series of constant-voltage pulses, as shown in FIG. 22B, using pulse-width-modulation-based representation of selected points along the exponential-decay curve 2202. The graph 2210 shown in FIG. 228 plots voltage with respect to time, just as the graph in FIG. 22A, but provides a discrete representation of the exponential decay function shown as a continuous function in FIG. 22A. FIG. 22B is derived from FIG. 22A by sampling the continuous function, shown in FIG. 22A, at discrete points in time, shown in FIG. 22A as “0,” “1,” and “2” along the time axis 2206. The pulse-width modulation technique described with reference to FIGS. 21A-B is employed to encode the sampled continuous-function value at each of these points in time into a constant-voltage pulse, with the constant-voltage pulses 2220-2222 representing the numeric value of the exponential-decay function at times “0,” “1,” and “2,” respectively. Note that, in FIG. 22B, the constant-voltage pulses have voltages of magnitude Vp 2224 below a threshold voltage 2226. The threshold voltage 2226 is the threshold voltage magnitude for memristive synapses of a neuromorphic circuit. As discussed above, when voltage drops applied across a memristic synapse have magnitudes below a threshold voltage magnitude for the synapses, the conductances of the memristive synapses changes very little, but, when voltage drops of magnitudes equal to, or above, the threshold voltage magnitude are applied to the memristic synapses, the conductances of the synapses change significantly, with each additional increment of voltage magnitude above the threshold voltage magnitude causing an non-linear increase in the conductances. In embodiments of the present invention, voltage pulses within each of various types of signals are maintained below the threshold voltage magnitude for the memristic synapses within neuromorphic circuits, so that the conductances of the synapses change only when a combination of forward and backward propagating signals produce super-threshold voltages under certain very special circumstances, described below.

Note that, were the continuous voltage-decay function shown in FIG. 21A applied to a synapse as a continuous voltage signal, the total change to the conductance of the synapse could be approximated by:

$$A ( {\int }_{0}^{{t}_{1}} f ( t ) ) + B ( {\int }_{{t}_{1}}^{∞} f ( t ) )$$

where

A is a relatively large-magnitude constant reflecting the large conductance changes that occur with applied voltage drops of above-threshold voltage magnitudes;

B is a very small-magnitude constant reflecting the tiny conductance changes that occur with applied voltage drops of below-threshold voltage magnitudes; and

t₁ is the time at which the voltage, ƒ(t), equals the threshold voltage.

This would produce a significant change in conductance when

$$( {\int }_{0}^{{t}_{1}} f ( t ) )$$

has a significant numerical value. By contrast, were the discrete representation of the function, shown in FIG. 22B, applied as a voltage signal across the synapse, only a very small conductance change would occur, approximated by:

$$B {\sum }_{i = 0}^{∞} {\int }_{{t}_{i}}^{{t}_{i} + pwm ( f ( {t}_{i} ) )} f ( t )$$

where pwm(ƒ(tᵢ)) is the duration of the pulse-width-modulation-based representation of the voltage value at time tᵢ.
This would produce a very small conductance change, compared with that produced by applying the continuous signal. As discussed below, in certain embodiments of the present invention, each positive voltage pulse is accompanied by an equal duration negative voltage pulse of the same magnitude in many of the signals used to implement learning, so that almost no conductance changes occur in synapses except for the special cases when two signals combine to produce a super-threshold voltage drop across a synapse.

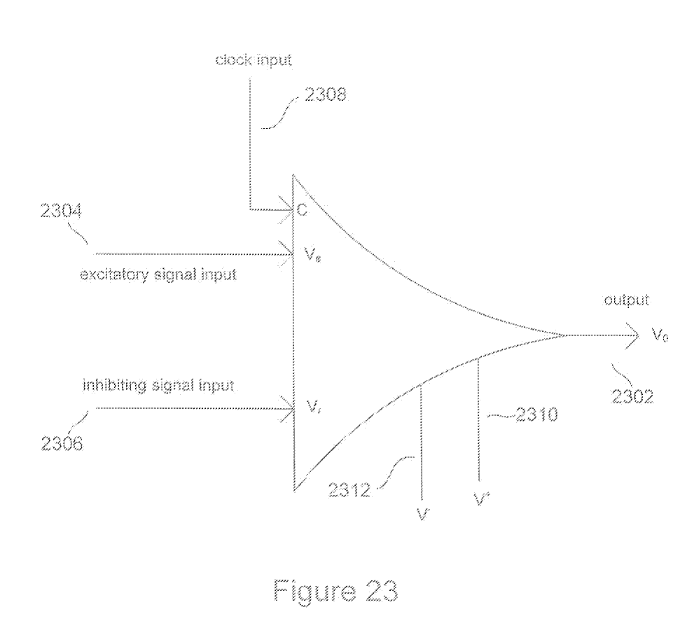

FIG. 23 shows a symbolic representation of a neuron, within a neuromorphic, circuit that represents an embodiment of the present invention, that can transmit signals through memristive synapses in synchrony with signal transmission by other neurons. In additional to the output 2302, excitatory input 2304, and inhibitory input 2306, the neuron additionally includes a clock input 2308, a constant positive voltage V⁺ 2310, and a constant negative voltage V⁻ 2312 input. In one embodiment of the present invention, all signals generated and transmitted by neurons include pulses of either V⁺ or V⁻ voltage with respect to a virtual ground voltage, V=0. The V⁺ and V⁻ inputs 2310 and 2312 provide voltages to the circuitry internal to the neuron. The clock input 2308 provides a timing signal, generally comprising a series of voltage spikes that occur at a fixed time interval, or ticks, to all neurons within a neuromorphic circuit, allowing the neurons to synchronize their signal transmission with one another.

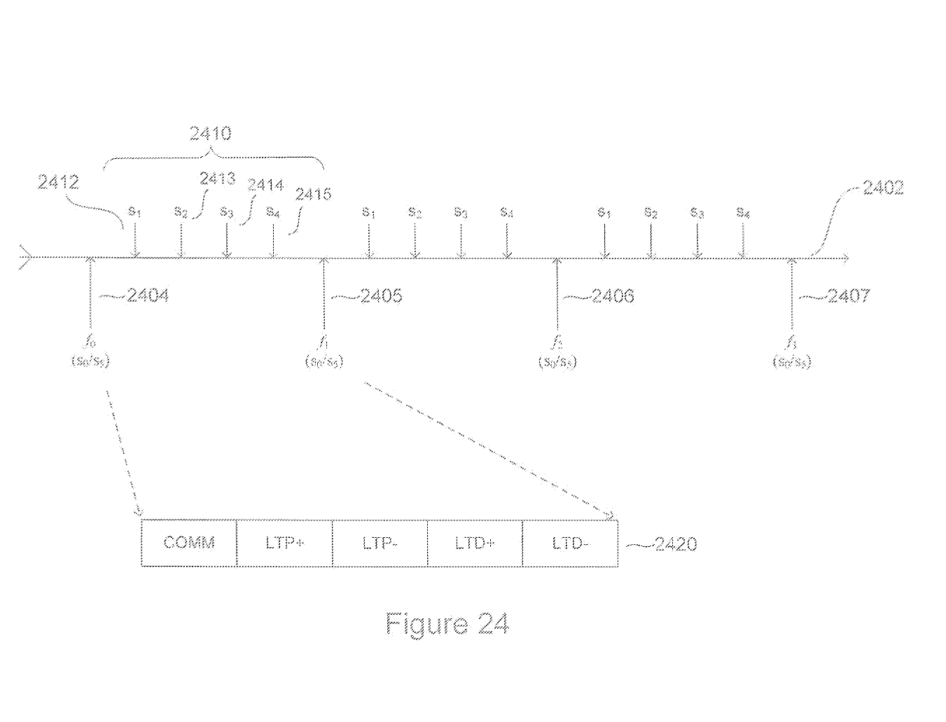

FIG. 24 illustrates a basic signal-synchronization model according to embodiments of the present invention. In FIG. 24, a horizontal axis 2402 represents time, increasing to the right as is the common convention. Time is divided into fixed intervals, referred to as frames, and each frame is further divided into slots. In FIG. 24, the points in time that represent frame boundaries, 2404-2407, are labeled “f₀,” “f₁,” “f₂” and “f₃,” respectively. Thus, frame f₀ refers to the period of time 2410 spanning the points in time f₀ 2404 to f₁ 2405. The frame f₀ is divided into five time slots, s₀, s₁, s₂, s₃, and s₄, each of equal size, with boundaries corresponding to the points in time f₀ 2404, s₁ 2412, s₂ 2413, s₃ 2414, s₄ 2415, and f₁ 2405. As shown by the expanded representation of the frame 2420 in FIG. 24, the five time slots are referred to as the “COMM,” “LTP⁺,” “LTP⁻” “LTD⁺,” and “LTD⁻” slots. The COMM slot is used for transmitting neuron spikes and any other neuron output. The LTP⁺ and LTP⁻ slots are employed for transmitting a long-term-potentiation signal from the output of one neuron to the input of one or more neurons, the voltage pulses in each LTP⁺/LTP⁻ of equal duration and magnitude, and opposite sign. The LTD⁺ and LTD⁻ slots are used for transmitting a long-term depression signal from the input terminals of one neuron to the output terminals of other neurons, the voltage pulses in each LTD⁺/LTD⁻ pair also of equal duration and magnitude, and opposite sign. As discussed above, by transmitting opposite-signed voltage signals in pairs, even the small below-threshold conductance changes that would occur from transmission of only one pulse of the pair are avoided by offsetting conductance changes produced by the pair of equal duration and equal magnitude pulses with opposite signs. Thus, as shown in FIG. 24, signal transmission in the clock-based synchronous neuromorphic circuit that represents one embodiment of the present invention occurs in regularly repeating frames, each frame divided into slots, each slot allowing for transmission of a different type of signal. The frame and slot boundaries coincide with clock ticks, with a fixed number of clock ticks per time slot and per frame.

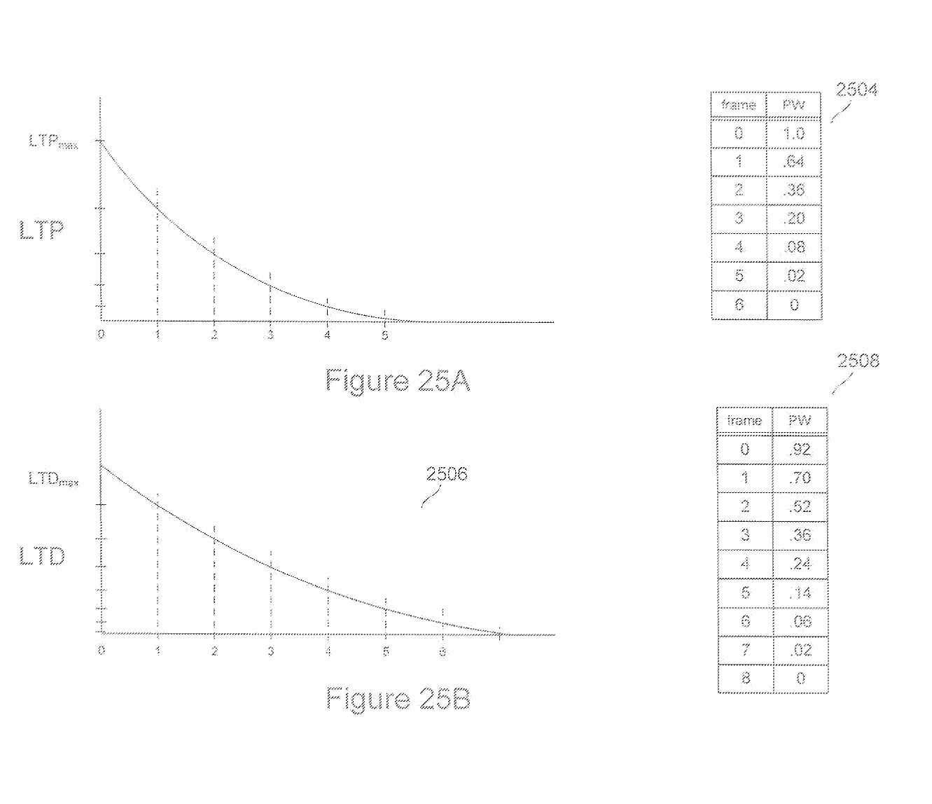

FIGS. 25A-B illustrate pulse-width-modulation representation of two different exponential-decay functions. The first exponential-decay function, the LTP function, shown in FIG. 25A, is used as the basis for generation and transmission of LTP⁺ and LTP⁻ signals. A sampling of this exponential-decay function and corresponding pulse widths are shown to the right of the function, in table 2504. Similarly, FIG. 25B shows a second exponential-decay function, LTD, 2506, used as the basis for generation of LTD⁺ and LTD⁻ signals. The pulse widths transmitted at various-sample times that represent this function are shown in table 2508 to the right of the function. Note that tables 2504 and 2508 show the pulse widths for each of the LTP and LDP signals included in each of a series of consecutive frames in which the signals are transmitted. The LTP function is used as the basis for an LTP signal used to change the conductances of memristive synapses according to the long-term-potentiation aspect of STDP learning model, and the LTD function is used as the basis for LTD signals that effect long-term depression of memristive synapses according to the STDP learning model. However, any of a variety of different learning models may be implemented, according to methods of the present invention, using different functions and corresponding pulse-width-modulation value tables. Note that the LTP function decays somewhat more quickly or, in other words, has a smaller time constant, than the LTD function. The differences between the LTP and LTD functions correspond to the differences in the left and right sides of the graph shown in FIG. 5, and discussed in the preceding subsection.

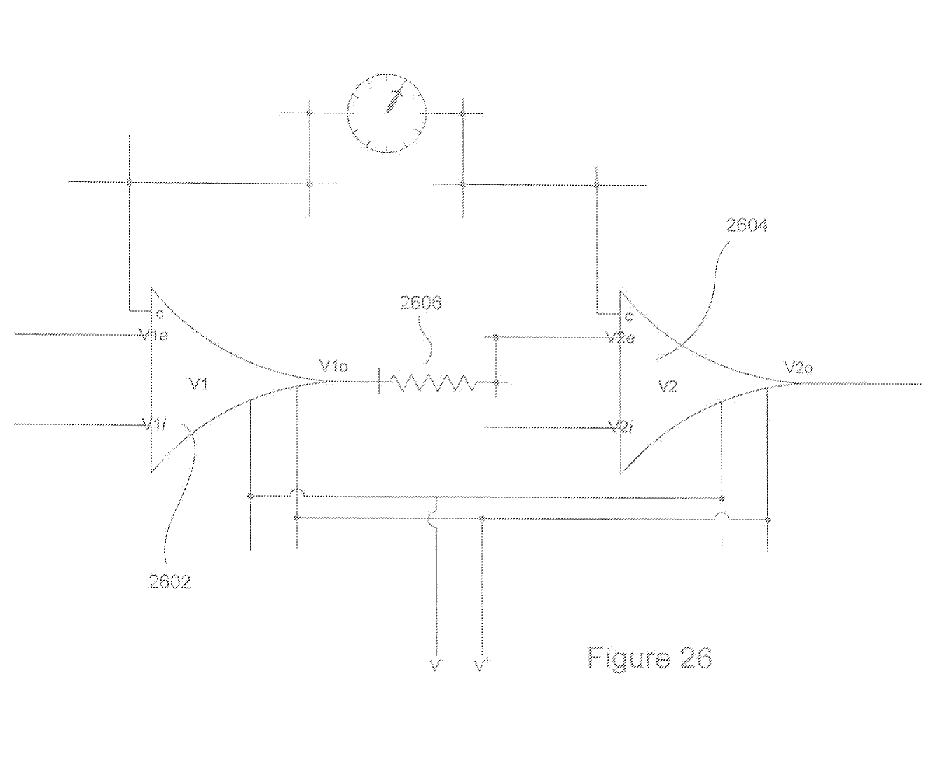

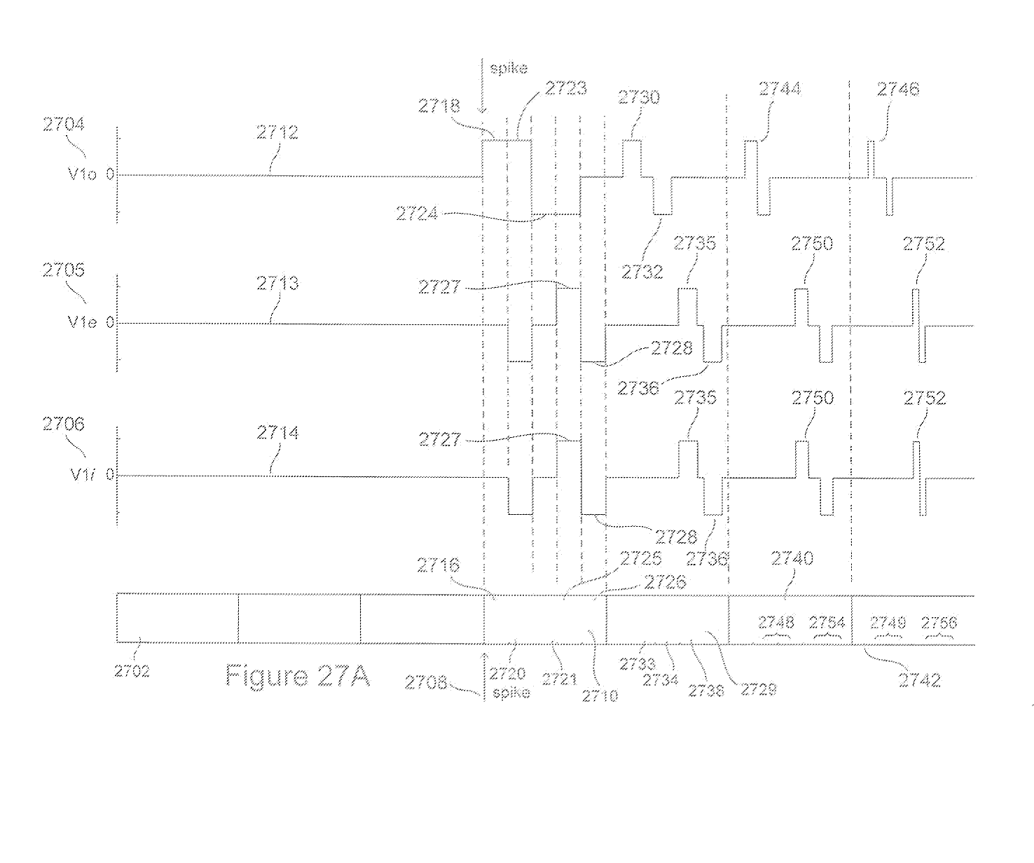

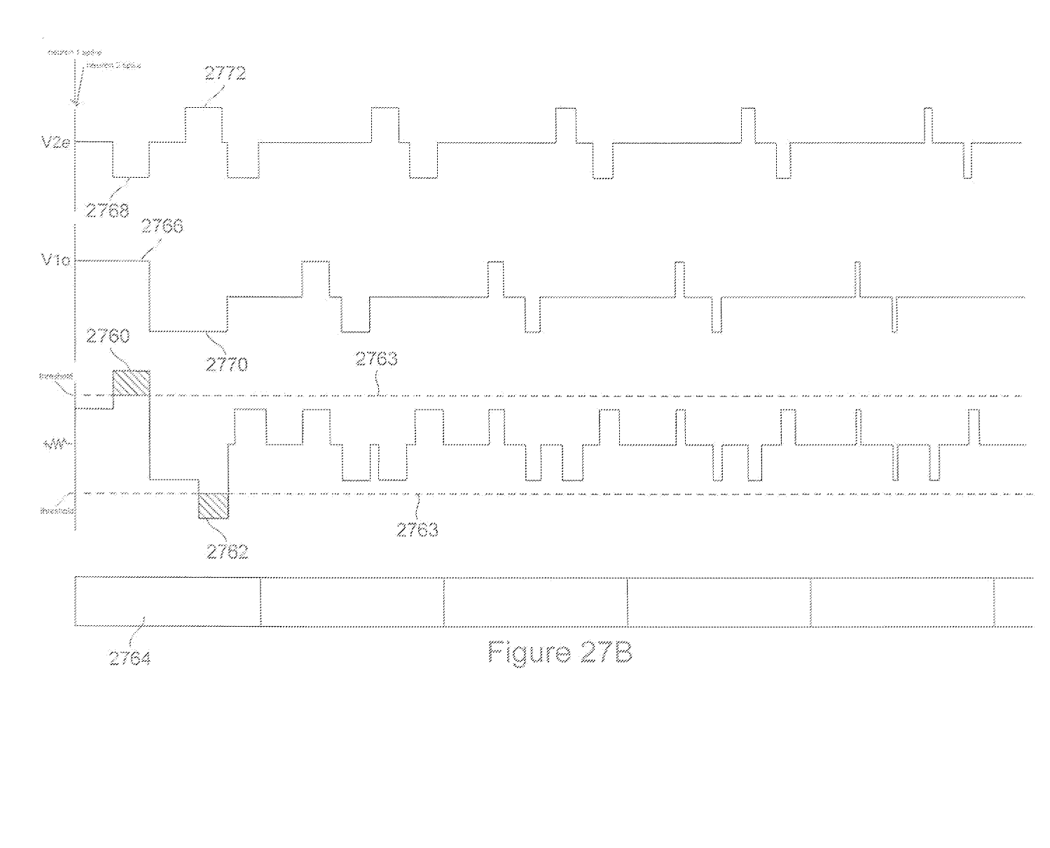

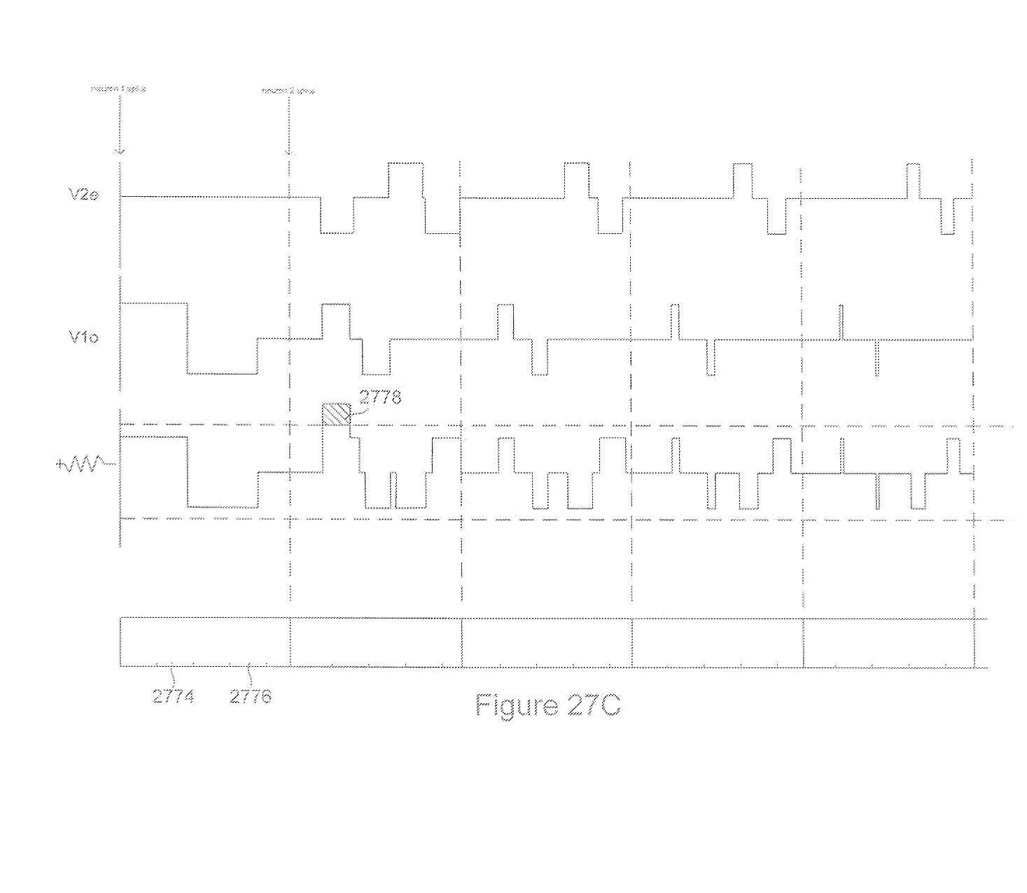

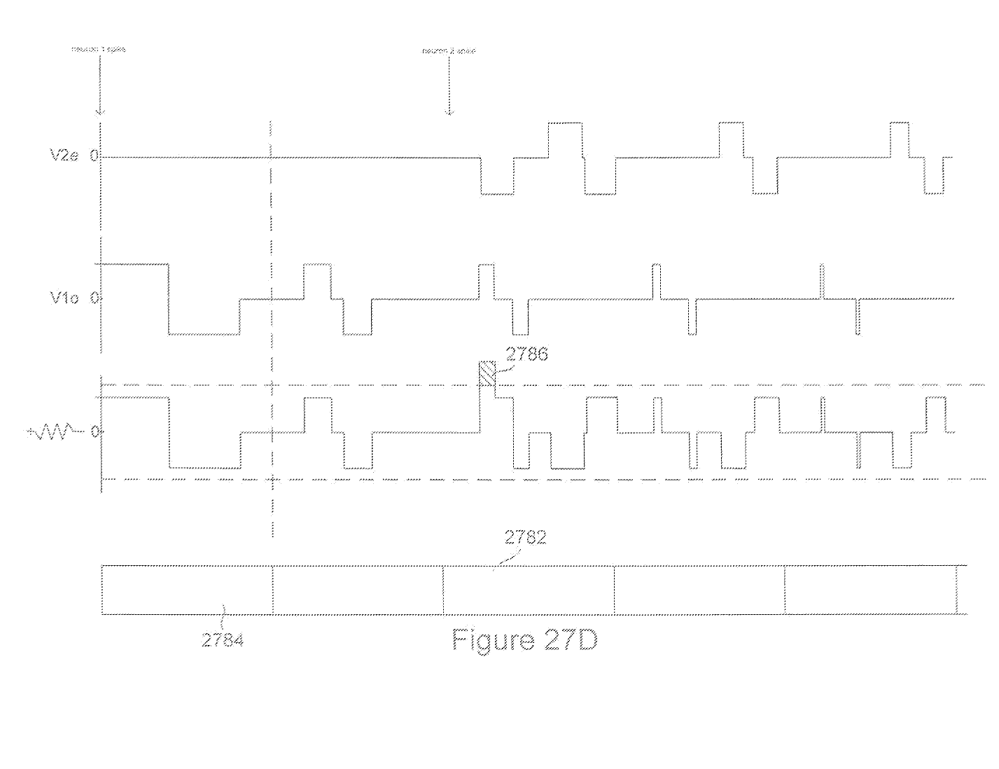

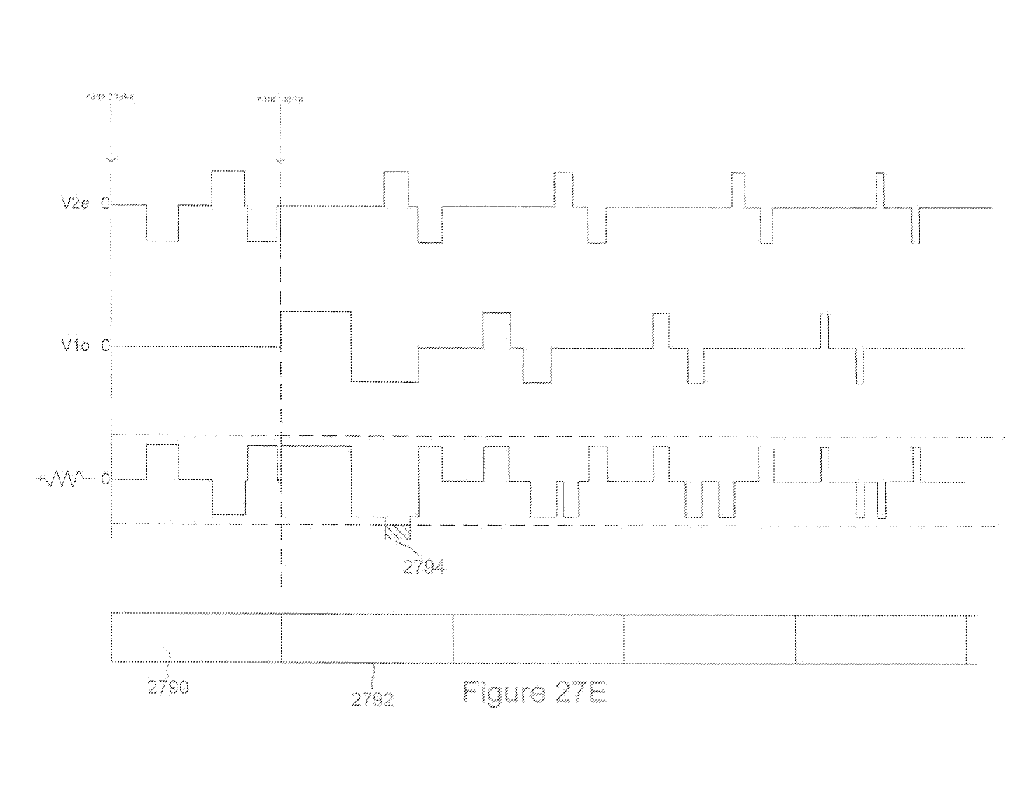

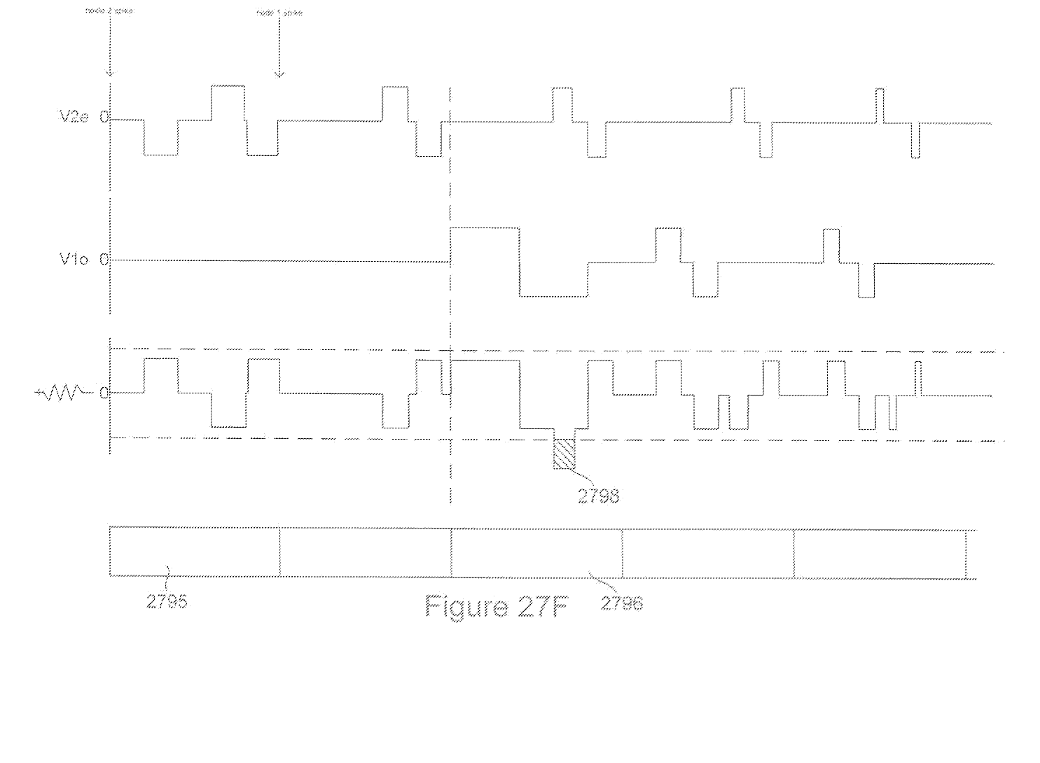

FIG. 26 shows two neurons within a neuromorphic circuit and alphanumeric labels for their output and inputs according to embodiments of the present invention. The first neuron 2602, V1, is referred to, in the following discussion, as the “pre” neuron, and the second neuron 2604, V2, is referred to as the “post” neuron. The memristive synapse 2606 joins the output of neuron V1 to the excitatory input of neuron V2. The described embodiment of the present invention uses constant-voltage-pulse signals. The voltages, at any given instance in time, at the output and input terminals of the two neurons are referred to by the character strings shown in FIG. 26. Excitatory input voltages end with the letter “e,” inhibitory inputs end with the “i,” and output terminal voltages end with the small character “o.” These naming conventions are used, in FIGS. 27A-27F, to illustrate the forms of the signals generated and transmitted by neurons in the neuromorphic circuit according to one embodiment of the present invention.

FIGS. 27A-F illustrate the constant-voltage-pulse signals generated and transmitted by neurons in a neuromorphic circuit according to embodiments of the present invention. FIGS. 27A-F all use the same illustration conventions. At the bottom of each figure, a representation of a series of successive frames, beginning with a first frame 2702, and slots within certain of the frames, is shown. The voltages, or voltage signals, at each of three different points in the portion of a neuromorphic circuit shown in FIG. 26 are shown plotted horizontally in three aligned plots 2704-2706. Plots are additionally aligned with the representation of successive frames at the bottom of the page.

FIG. 27A shows the signals generated by a spiking neuron. The signal generated at the output for the neuron is plotted in plot 2704, and the signals generated at the excitatory and inhibitory inputs of the neuron are shown in plots 2705 and 2706. Please note that, in the described embodiment of the present invention, the equivalent of backward-propagating voltage signals are output to input signal lines in order to combine with incoming signals to produce, a certain times, super-threshold voltage drops across memristive synapses in order to effect learning according to a learning model, such as the STDP model. Prior to the occurrence of a spike 2708, at the beginning of the fourth frame shown in FIG. 27A, 2710, the signals output by the neuron are flat or, in other words, constant virtual-zero voltage signals 2712-2714. Spikes are aligned with frame boundaries. Thus, at some time preceding the left boundary of frame 2710, internal processing circuitry within the neuron V1 determined that a spike should be emitted in the fourth 2710 and subsequent frames.

In the COMM slot 2716 of the fourth frame 2710, the spiking neuron V1 outputs a positive voltage pulse 2718 spanning the slot. This is the spike signal that may be employed, by any receiving downstream neurons, to themselves determine, at least in part, when to subsequently spike. In the LTP⁺ and LTP⁻ time slots 2720-2721 of the fourth frame, the neuron outputs opposite-signed voltage pulses with widths, or durations, equal to the PWM value shown in the first entry in table 2504 in FIG. 25A. A positive pulse 2723 is transmitted in the LTP⁺ slot 2720, and a corresponding negative pulse 2724 is issued in the LTP⁻ slot 2721. In the LTD⁺ and LTD⁻ slots 2725-2726, the spiking neuron emits, on each input terminal, a positive voltage pulse 2727 and negative voltage pulse 2728, respectively, of duration, or width, equal to the width shown in the first entry of table 2508 in FIG. 25B. As discussed below, a forward-propagating LTP signal may combine with a backward-propagating LDP signal to produce a super-threshold voltage drop across a memristive synapse, and therefore change the conductances of the synapse, according to the STDP learning model.

In the next, fifth frame 2729, the neuron V1 outputs an LTP⁺ 2730 and LTP⁻ 2732 pulse pair with pulse widths equal to that indicated in the second entry in the table 2504 in FIG. 25A in the LTP⁺ time slot 2733 and LTP⁻ time slot 2734, and emits positive LTD⁺ 2735 and negative LTD⁻ 2736 signals 2735-2748 to the input terminals in the LTD⁺ and LTD⁻ time slots 2738 and 2739 of the fifth frame 2729. In subsequent frames 2740 and 2742, LTP⁺ and LTP⁻ signal pairs 2744 and 2746 are output in the LTP⁺ and LTP⁻ time slots 2748 and 2749, with decreasing widths according to the third and fourth entries of table 2504 in FIG. 25A, and LTD⁺ and LTD⁻ signal pairs 2750 and 2752 are emitted at the input terminals in the LTD⁺ and LTD⁻ time slots 2754 and 2756, with decreasing pulse widths according to the third and fourth entries of table 2508 in FIG. 25B. Thus, a spiking neuron emits a single spike pulse 2718 in the first frame that coincides with the spike, along with maximally valued LTP⁺/LTP⁻ and LTD⁺/LTD⁻ signals, and then, in subsequent frames, continues to output LTP⁺/LTP⁻ and emit LTD⁺/LTD⁻ signals, with decreasing pulse widths, with each subsequent frame until the LTP and LDP functions have decayed, with full decay represented by 0 entries in tables 2504 and 2508.

FIGS. 27B-F illustrate STDP learning based on the signals described with reference to FIG. 27A. In each of FIGS. 27B-F, the signal output to the input terminal of the post neuron V2e, the signal output to the output terminal of the pre neuron V1o, and the voltage drop across the memristive synapse connecting the two neurons (2606 in FIG. 26) are shown as the first, second, and third signal plots in each figure.

FIG. 27B shows, the voltages at the excitatory input of the post neuron V2, at the output of the pre neuron V1, and the voltage drop across the connecting memristive synapse when both the post neuron and pre neuron spike simultaneously, in a common frame. The voltage across the memristive synapse is equal to, at each point in time, the voltage V1o-V2e, according to the voltage convention discussed with reference to FIGS. 19B-C. Super-threshold voltage drops across a memristive synapse are shown in crosshatch, such as super-threshold voltage drops 2760 and 2762 in FIG. 27B. Threshold voltage magnitudes are shown as dashed lines 2763. When both neurons spike simultaneously, or within a single frame 2764, a super-threshold voltage occurs when the pre neuron is outputting the maximally-valued LTP⁺ signal 2766 in the LTP⁺ time slot of the first frame while the post neuron outputs a negative pulse of maximum magnitude 2768 in the same time slot. Similarly, a super threshold voltage 2762 occurs when, in the LTD⁺ time slot, the pre neuron transmits a maximal magnitude LTD⁻ signal 2770 and the pre neuron transmits a maximal magnitude positive LTD⁺ signal 2772. No other super-threshold voltage drops occur in the case of simultaneous spiking, and because the positive and negative super-threshold voltage drops 2760 and 2762 exactly offset, there is essentially no conductance change to the memristive synapse 2606 for simultaneous spiking.

FIG. 27C shows a case when the pre neuron spikes in the first frame 2774 and the post neuron spikes in the second frame 2776. In this case, a single positive super-threshold voltage 2778 is generated in the LTP⁺ time slot of the second frame, leading to a conductance increase in the memristive synapse and, therefore, positive LTP learning according to the STDP model. When, as shown in FIG. 27D, the post neuron spikes in a third frame 2782 following spiking of the pre neuron in the first frame 2784, a single, somewhat smaller super-threshold voltage 2786 is generated during the LTP⁺ time slot of the third frame, causing a smaller conductance increase in the memristive synapse joining the two neurons. The increase in conductance decreases exponentially as the spiking of the post neuron lags spiking of the pre neuron by additional frames, according to the STDP model. Once the LTP and LTD functions have fully decayed, no further conductivity changes occur.

FIG. 27E illustrates a case where the post neuron spikes in the first frame 2790 while the pre neuron spikes in the second frame 2792. This is a case in which neuron firing, or spiking, is out of order, with the post neuron-spiking prior to spiking of the pre neuron. In this case, a single super-threshold voltage 2794 occurs in the second frame, leading to a conductance decrease, as expected for LTD according to the STOP model. As shown in FIG. 27F, when the post neuron spikes in the first frame 2795 and the pre neuron spikes in the third frame 2796, the duration of the super-threshold negative voltage across the memristive synapse 2798 is smaller than when the pre neuron spikes in the frame immediately after the frame in which the post neuron spikes, as shown in FIG. 27E. Thus, according to the LTD characteristic of the STOP learning model, synapse conductance decreases when spiking is out of order, and the amount of conductance decrease decays exponentially as the spikes are further and further separated in time.

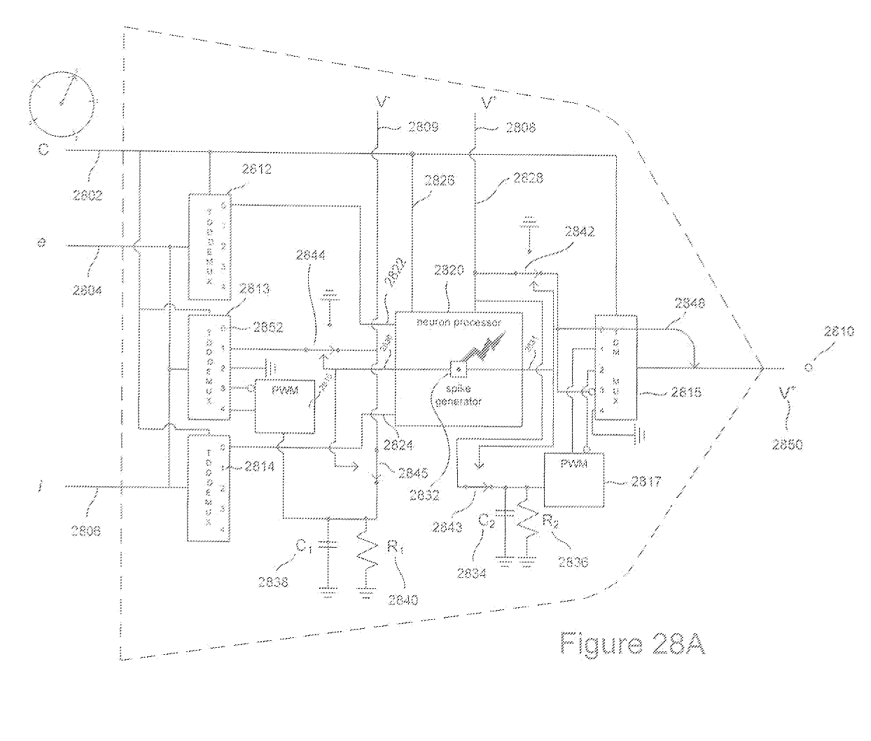

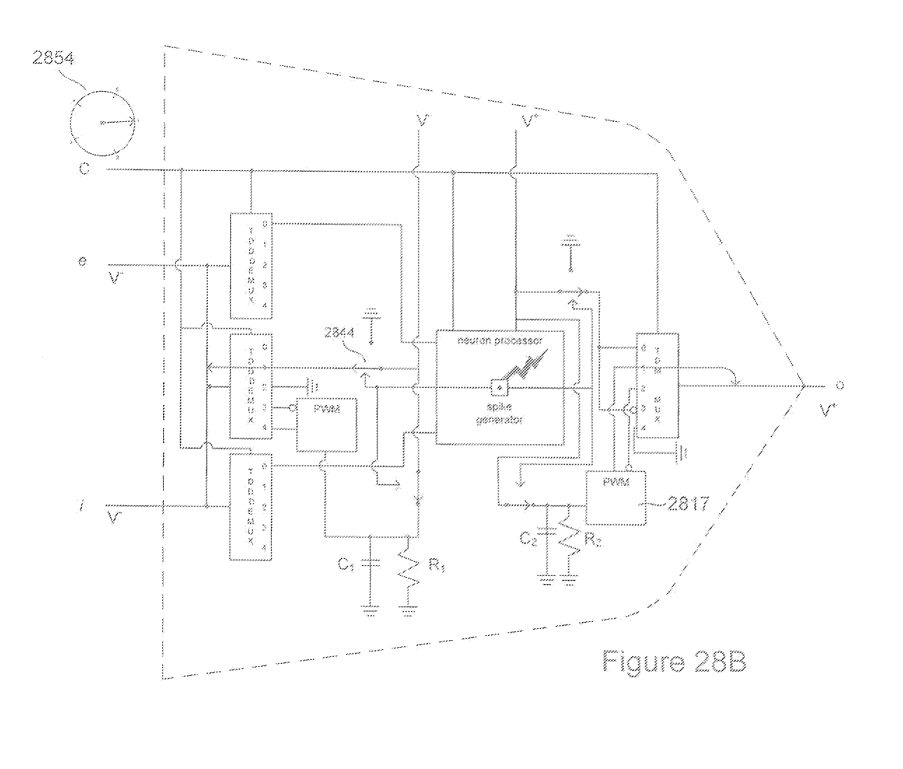

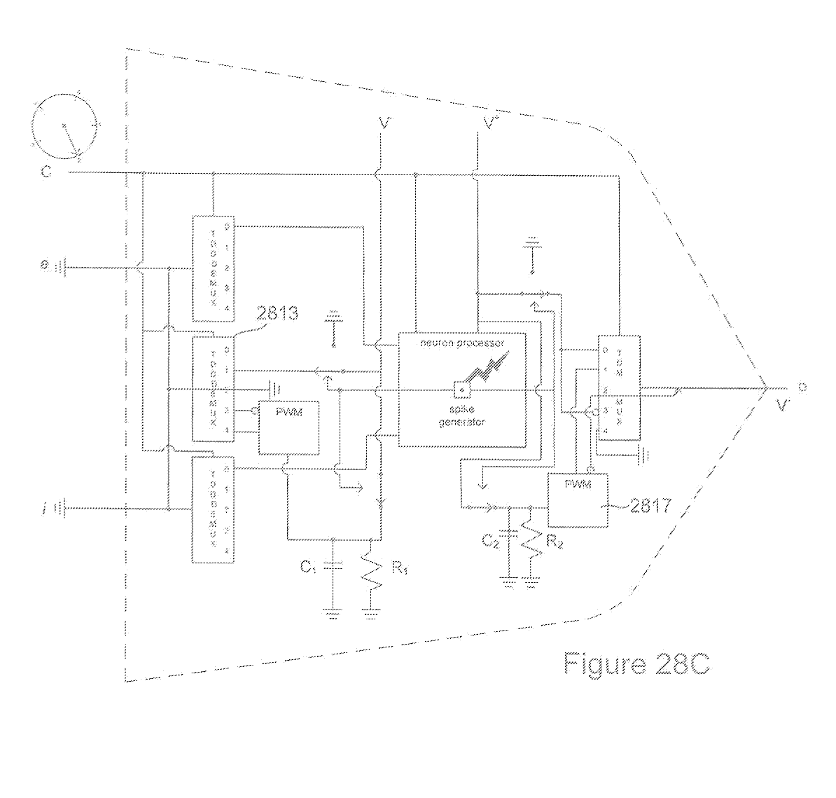

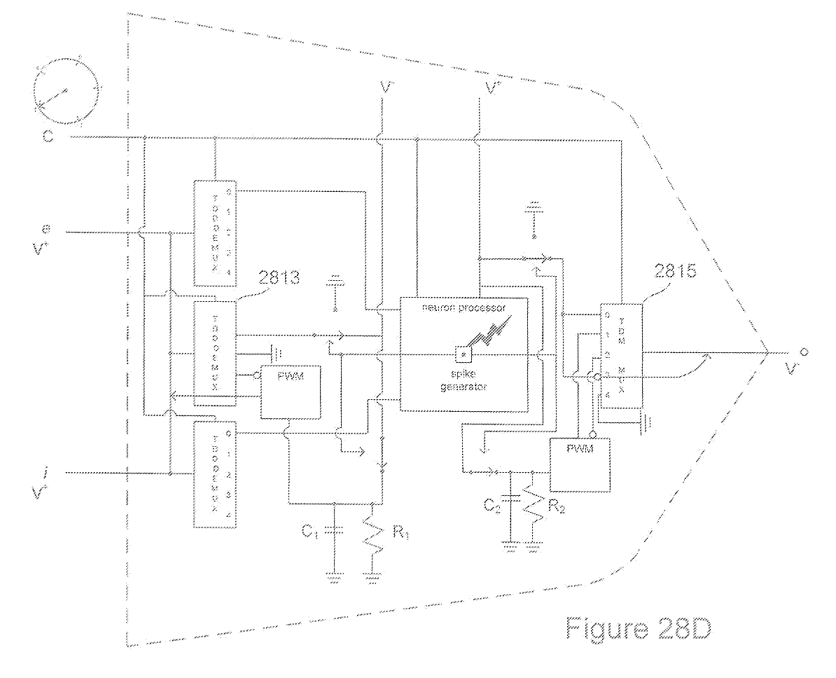

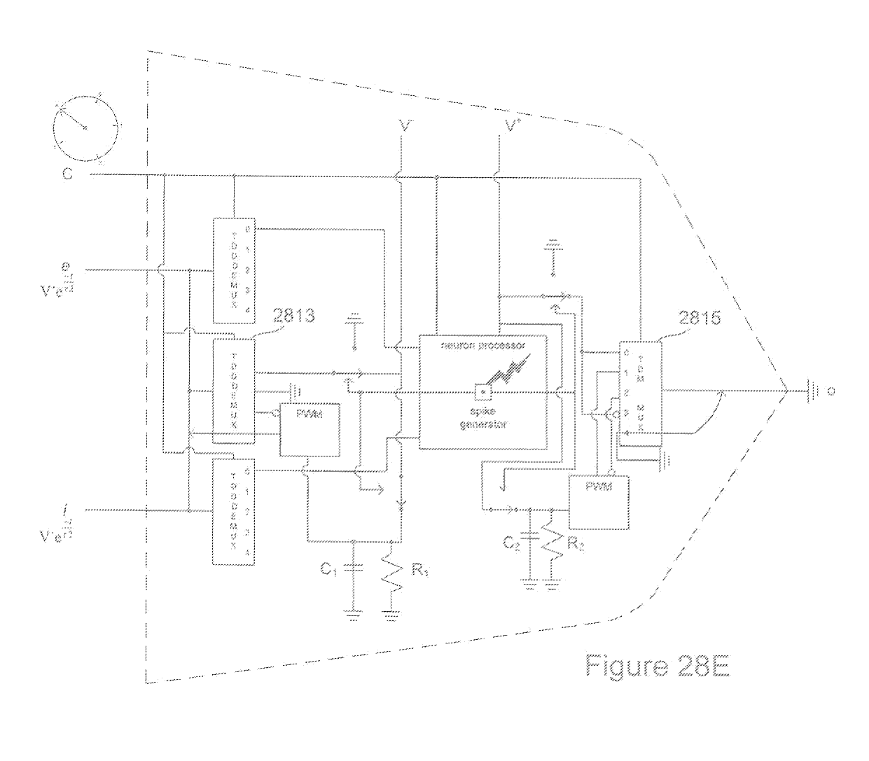

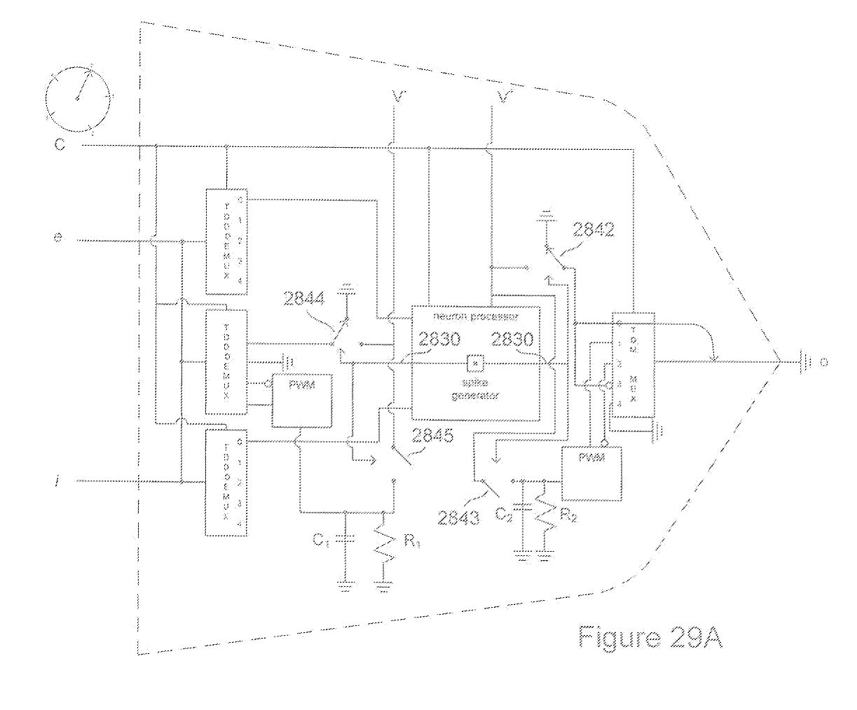

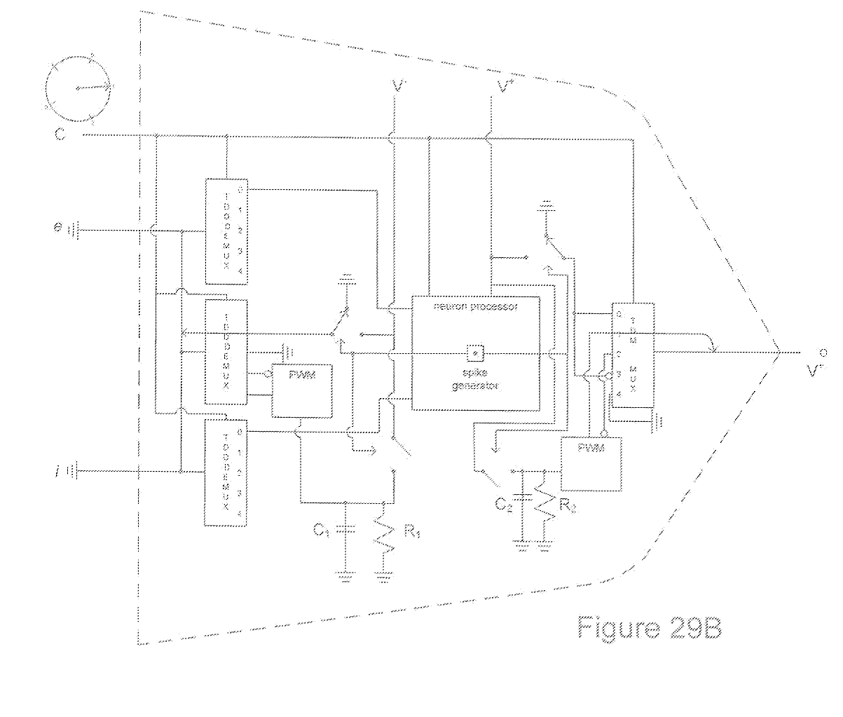

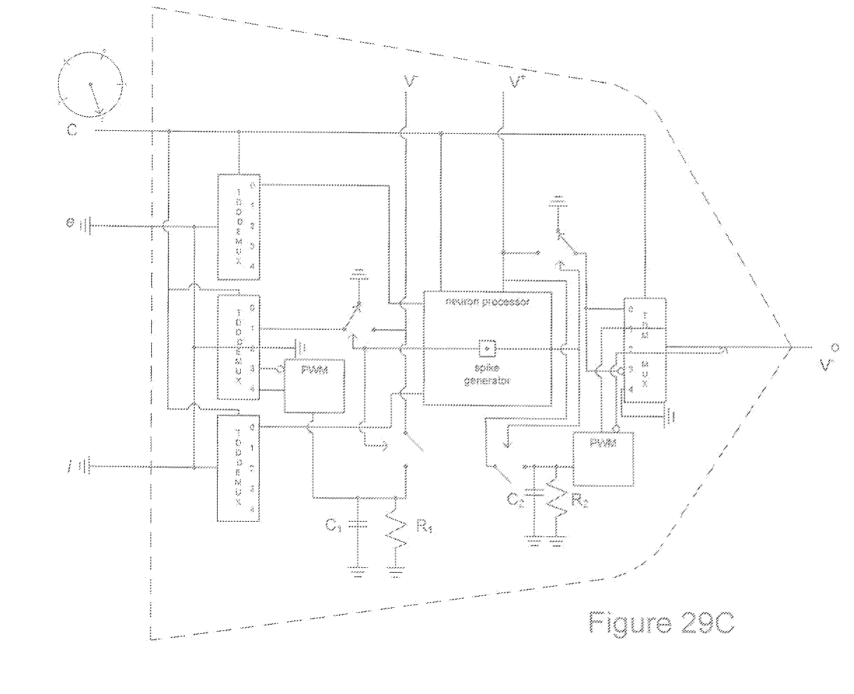

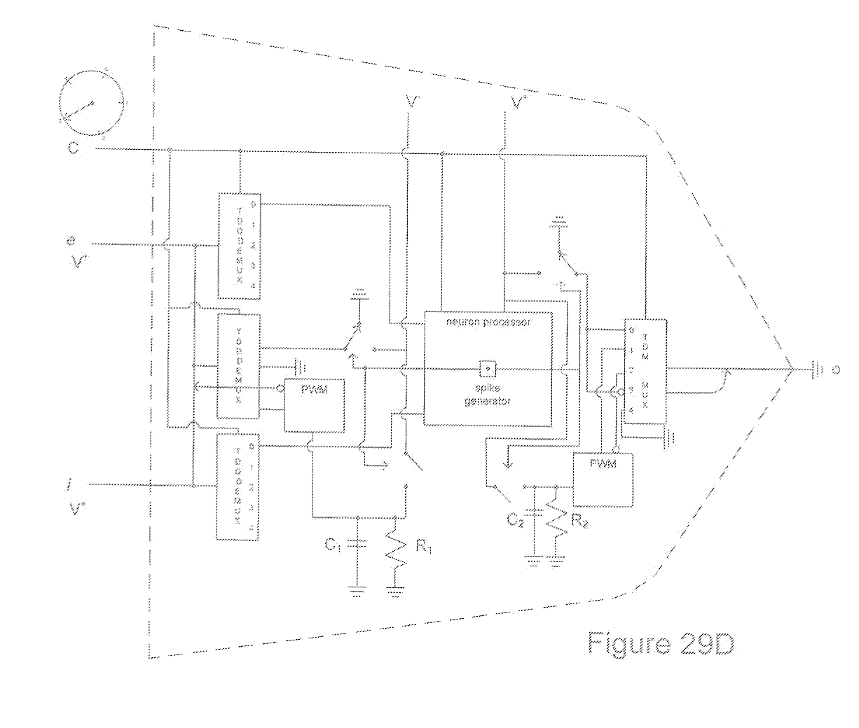

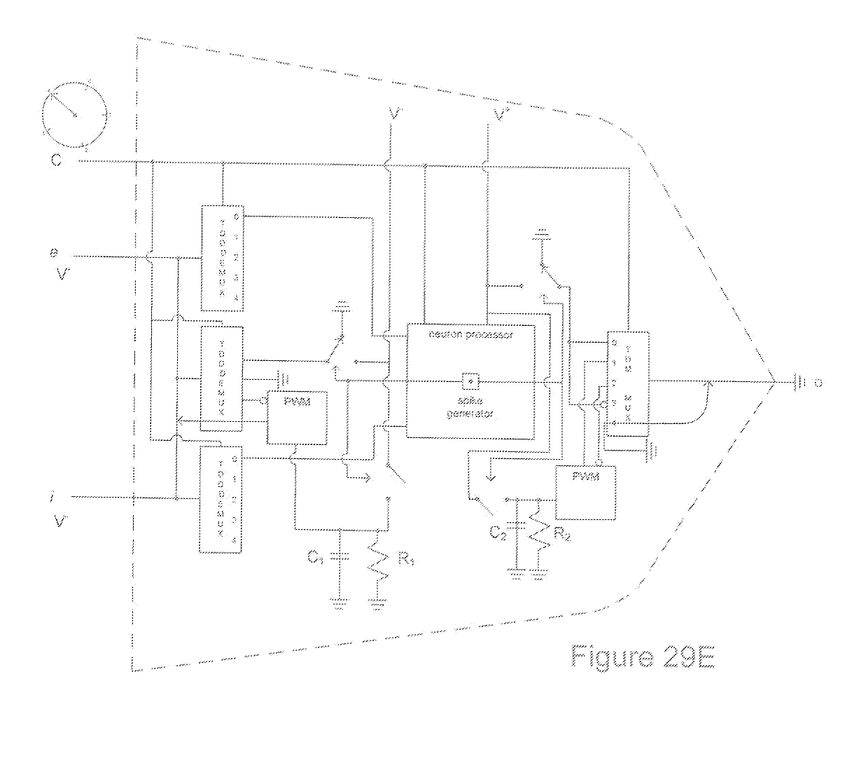

FIGS. 28A-29E illustrate one implementation of neuromorphic-circuit-neuron signal-processing logic that generates the synchronized signals shown in FIG. 27A-F according to embodiments of the present invention. FIGS. 28A-29E all use identical illustration conventions, discussed next with reference to FIG. 28A. The neuron implementation includes a clock-input signal line 2802, an excitatory input signal line 2804, an inhibitory input signal line 2806, a positive constant voltage input 2808, a negative constant voltage input 2809, and an output signal line 2810. The clock input controls four time-division-demultiplexing demultiplexors (“TDD DEMUXs”) 2812-2814 and a time-division-multiplexing multiplexor (“TDM MUX”) 2815. Two pulse-width-modulation units 2816 and 2817 (“PWM units”) convert an input continuous-voltage signal into a corresponding constant-voltage pulse, as discussed above with reference to FIGS. 21A-22B. Although not shown in FIGS. 28A-29E, the PWM units are controlled either directly by the input clock signal or indirectly by the neuron processor to emit constant-voltage PWM pulses at appropriate times. The neuron processing circuitry 2820 receives the excitatory and inhibitory inputs 2822 and 2824, clock input 2826, and the positive-voltage input 2828, and outputs spike signals 2830 and 2831 generated by a spike generator 2832. The capacitor C₂ 2834 and resistor R₂ 2836 combine to produce a time constant τ₂ that characterizes the LTP exponential-decay function, and the capacitor C₁ 2838 and resistor R₁ 2840 combine to produce the time constant τ₁ that characterizes the LTD exponential-decay function.

Each of FIGS. 28A-28E corresponds to each of successive time slots of a first frame of a spiking neuron. Thus, FIGS. 28A-E show production of the voltage signals shown in FIG. 27A corresponding to the first frame (2710 in FIG. 27A) of a spiking neuron. In time slot 0, or the COMM time slot, the spike signal generated by the spike generator 2832 of the neuron processor closes four switches 2842-2845 that remain closed throughout the first frame, depicted in FIGS. 28A-28E. The clock signal input to each of the TDD DEMUXs cause output of the slot-0 input to the TDM MUX. Because switch 2842 is closed by the spike signal, the V⁺ voltage input to time-slot-0 input 2848 of the TDM MUX 2815 is passed to the output signal line 2810, which therefore has the voltage value V⁺ 2850. Because switches 2843 and 2845 are closed, the capacitors C₁ and C₂ are charged to full capacity during the first frame. There is no signal connected to the time-slot-0 input 2852 of TDD DEMUX 2813, and therefore no signal is output to either of the excitatory 2804 or inhibitory 2806 inputs.

As shown in FIG. 28B, when the clock input 2854 indicates beginning of the second time slot, or LTP⁺ time slot, of the first frame, a positive LTP⁺ signal is output from PWM unit 2817, generally of duration equal to the PWM value corresponding to voltage

$${V}^{+} {e}^{\frac{t}{- {τ}_{2}}} ,$$

but since t is equal to 0 in the first frame, the output signal has maximum duration. V⁻ is output to both the inhibitory and excitatory terminals through switch 2844.

In the third time slot of the first frame, as shown in FIG. 28C, a negative voltage pulse is output from the PWM unit 2817 to output, generally of duration corresponding to the PWM value computed from the voltage

$${V}^{+} {e}^{\frac{t}{- {τ}_{2}}} ,$$

but, since t=0, of maximum duration the first frame. The excitatory and inhibitory inputs are connected to ground through the TDD DEMUX 2813. In the fourth time slot of the first frame, the V⁺ constant voltage is inverted and output to the output terminal through TDM MUX 2815, and the positive-magnitude LTD⁺ signal, generally of duration equal to the PWM value corresponding to the voltage

$${V}^{+} {e}^{\frac{t}{- {τ}_{1}}}$$

but, in the first frame, having maximum duration, is output through TDD DEMUX 2813 to both the inhibitory and excitatory input terminals. Finally, in the fifth time slot of the first frame, the output terminal is connected to ground by TDM MUX 2815 and the negative LTD⁻ pulse, generally equal in duration to the PWM value corresponding to the voltage

$${V}^{-} {e}^{\frac{t}{- {τ}_{1}}} ,$$

but in the first frame of maximum duration is output through TDD DEMUX 2813 through to the excitatory and inhibitory input terminals. Thus, considering FIGS. 28A-E and FIG. 27A, it is easily seen how each of the voltage pulses that occur at the terminals of a neuron during the first frame of a neuron spike are generated by the implementation shown in FIGS. 28A-E.

FIGS. 29A-E show generation of the terminal voltages during non-spiking frames by the implementation that represents one embodiment of the present invention. As shown in FIG. 29A, the absence of the spike signal on spike-signal lines 2830-2831 opens switches 2842-2845. These switches remain open in all, non-spike-coincident frames. When switches 2843 and 2845 are opened, the capacitors C₂ and C₁ discharge, over time, producing the LTP and LTD exponential-decay functions, described above. In each of the frames in FIG. 27A following frame 2710, a similar voltage signal is shown at each terminal, with the pulse widths of the LTP⁺/LTP⁻ and LTD⁺LTD⁻ signals narrowing in successive frames. Of course, when the LTP and LDP functions have decayed, or when capacitors C₁ and C₂ are fully discharged, and when no further spiking occurs, only virtual-ground, 0V voltages are output at all neuron terminals. Also, as is clear from the implementation shown in FIG. 28A, when a neuron spikes before the LTP and LTD functions of a previous spike have fully decayed, the LTP and LTD functions are reset by the most recent spike to their maximum values by charging of the capacitors C₁ and C₂.

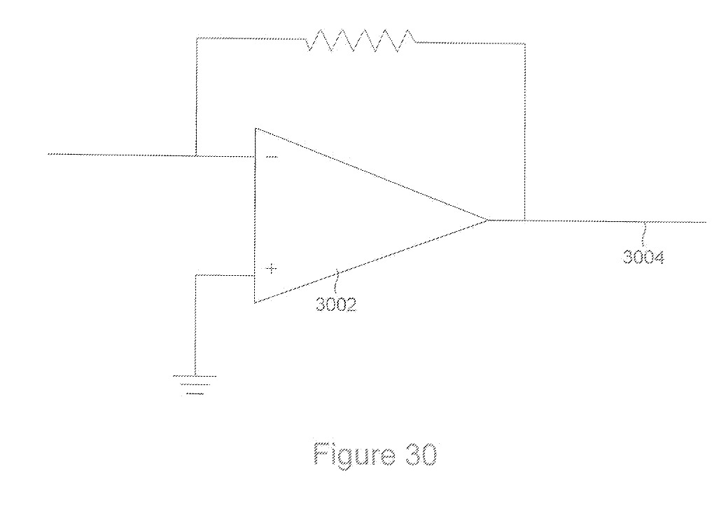

Finally, FIG. 30 shows one possible implementation of a virtual ground circuit that may be used to connect input signals to neurons according to embodiments of the present invention. The virtual-ground implementation uses a summing amplifier 3002 to sum all input currents, and converts the sum to an output voltage 3004.

Although the present invention has been described in terms of particular embodiments, it is not intended that the invention be limited to these embodiments. Modifications within the spirit of the invention will be apparent to those skilled in the art. For example, neurons can be implemented to generate and transmit synchronous signals to multiple outputs based on inputs received from one or more inhibitory inputs and/or one or more excitatory inputs. While the STDP model is discussed, in above implementations, any of various different learning models may be implemented by varying the signals generated and produced at output and input terminals of each neuron. While a five-slot frame is used, according to a preferred embodiment of the present invention, fewer or a greater number of slots may be used, per frame. For example, positive and negative spike voltages may be output in COMM⁺ and COMM⁻ time slots to further reduce unwanted synapse conductance changes. Implementations may use voltage and current signals, voltage signals, or current signals. An almost limitless number of different neuron processing-circuitry implementations may be employed. While an exemplary circuit implementation of the signal generation and signal transmission portions of a neuron are shown, in FIGS. 28A-29E, many additional implementations are possible, using different components, interconnections, and organizations. The above-discussed embodiments focus on internal neurons of a neuromorphic circuit, which receive signals from upstream neurons and transmit signals to downstream neurons. A neuromorphic circuit often includes well, interface neurons that receive signals from external inputs and that transmit signals to external outputs. In certain embodiments, the interface neurons may not employ frame-based synchronization for receiving external inputs and outputting external outputs, but may adhere to another convention used within the circuits of devices external to the neuromorphic circuit.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A neuromorphic circuit comprising:
two or more internal neuron computational units, each internal neuron computational unit including a synchronization-signal input for receiving a synchronizing signal, at least one input for receiving input signals, and at least one output for transmitting an output signal; and
memristive synapses that each interconnects an output signal line carrying output signals from a first set of one or more internal neurons to an input signal line that carries signals to a second set of one or more internal neurons.

2. The neuromorphic circuit of claim 1 wherein each internal neuron employs the synchronizing signal to divide time into frames, each frame comprising two or more time slots.

3. The neuromorphic circuit of claim 2 wherein, during each time slot of each frame, each internal neuron can transmit and/or receive a signal of a particular type of signal associated with the time slot.

4. The neuromorphic circuit of claim 3 wherein signals transmitted by an internal neuron during each of the time slots of each frame are sub-threshold signals that, without combination with additional signals, fall below a threshold signal-strength magnitude with respect to any memristive synapse through which the signals pass.

5. The neuromorphic circuit of claim 4 wherein each frame includes:
a COMM time slot;
an LTP⁺ time slot;
an LTP⁻ time slot;
an LTD⁺ time slot; and
an LTD⁻ time slot.

6. The neuromorphic circuit of claim 5 wherein:
during the COMM time slot, an internal neuron can transmit an output signal to one or more downstream neurons;
during the LTP⁺ time slot, the internal neuron can transmit a positive LTP⁺ signal of an LTP⁺/LTP⁻ signal pair;
during the LTP⁻ time slot, the internal neuron transmits a negative LTP⁻ signal of the LTP⁺/LTP⁻ signal pair;
during the LTD⁺ time slot, the internal neuron can transmit a positive LTD⁺ signal of an LTD⁺/LTD⁻ signal pair; and
during the LTD⁻ time slot, the internal neuron transmits a negative LTD⁻ signal of the LTD⁺/LTD⁻ signal pair.

7. The neuromorphic circuit of claim 6 wherein a spiking internal neuron, during the first frame coincident with spiking, transmits:
a spike signal to one or more outputs during the COMM time slot;
a maximum LTP⁺ signal to one or more outputs during the LTP⁺ time slot;
a maximum LTP⁻ signal to one or more outputs during the LTP⁻ time slot;
a maximum LTD⁻ signal to one or more outputs during the LTD⁺ time slot;
a maximum LTP⁻ signal to one or more inputs during the LTP⁺ time slot;
a maximum LTD⁺ signal to one or more inputs during the LTD⁺ time slot;
a maximum LTD⁻ signal to one or more inputs during the LTD⁻ time slot.

8. The neuromorphic circuit of claim 6 wherein a non-spiking internal neuron, during each frame following spiking, transmits:
an LTP⁺ signal to one or more outputs during the LTP⁺ time slot of a magnitude representing a current value of an LTP function that exponentially decays from a maximum value at the time of spiking;
an LTP⁻ signal to one or more outputs during the LTP⁻ time slot of a magnitude representing a current value of an LTP function that exponentially decays from a maximum value at the time of spiking;
an LTD⁺ signal to one or more inputs during the LTD⁺ time slot of a magnitude representing a current value of an LTP function that exponentially decays from a maximum value at the time of spiking; and
an LTD⁻ signal to one or more inputs during the LTD⁻ time slot of a magnitude representing a current value of an LTP function that exponentially decays from a maximum value at the time of spiking.

9. The neuromorphic circuit of claim 6 wherein, when a first internal neuron with an output connected to an input of a second internal neuron through a memristive synapse spikes in a first frame and the second internal neuron spikes in a second frame that follows the first frame, and when the LTP function of the first internal neuron has not decayed to 0 value, the LTP⁺ signal transmitted by the first internal neuron during the LTP⁺ time slot combines with the maximum LTP⁻ signal transmitted by the second internal neuron to one or more inputs of the second internal neuron during the LTP⁺ time slot to produce a positive super-threshold signal above a threshold signal strength with respect to the memristive synapse.

10. The neuromorphic circuit of claim 6 wherein, when a first internal neuron with an output connected to an input of a second internal neuron through a memristive synapse spikes in a second frame and the second internal neuron spikes in a first frame that precedes the first frame, and when the LDP function of the second internal neuron has not decayed to 0 value, the LTD⁻ signal transmitted by the first internal neuron during the LTD⁺ time slot to one or more outputs combines with the LTD⁺ signal transmitted by the second internal neuron to one or more inputs of the second internal neuron during the LTP⁺ time slot to produce a negative super-threshold signal below a threshold signal strength that negatively reinforces the memristive synapse.

11. The neuromorphic circuit of claim 1 wherein the memristive synapses exhibit non-linear, positive conductance changes as a result of applied super-threshold positive voltages, non-linear, negative conductance changes as a result of applied super-threshold negative voltages, and very small conductance changes as a result of applied voltages with magnitudes below a threshold voltage magnitude.

12. The neuromorphic circuit of claim 1 wherein internal neurons emit voltage signals at outputs and inputs and receive current signals at inputs, transforming received current signals into internal voltage signals by a virtual-ground circuit.

13. A method for effecting learning in a neuromorphic circuit, the method comprising:
providing the neuromorphic circuit having two or more internal neuron computational units, each internal neuron computational unit including a synchronization-signal input for receiving a synchronizing signal, at least one input for receiving input signals; and at least one output for transmitting an output signal, and memristive synapses that each interconnects an output signal line carrying output signals from a first set of one or more internal neurons to an input signal line that carries signals to a second set of one or more internal neurons; and
transmitting signals by internal neurons within the neuromorphic that fall below a threshold signal-strength magnitude with respect to any memristive synapse through which the signals pass, but that, under circumstances in which internal neurons coupled through a memristive synapse both fire within the decay time of an exponential decay function, combine to produce a signal, a portion of which is greater, in magnitude, than a threshold signal-strength magnitude with respect to the memristive synapse, changing the conductance of the memristive synapse according to a learning model.

14. The method of claim 13
wherein each internal neuron employs the synchronizing signal to divide time into frames, each frame comprising two or more time slots; and
wherein during each time slot of each frame, each internal neuron can transmit and/or receive a signal of a particular type of signal associated with the time slot.

15. The method of claim 14
wherein each frame includes a COMM time slot, an LTP⁺ time slot, an LTP⁻ time slot, an LTD⁺ time slot, and an LTD⁻ time slot;
wherein during the COMM time slot, an internal neuron can transmit an output signal to one or more downstream neurons, during the LTP⁺ time slot, the internal neuron can transmit a positive LTP⁺ signal of an LTP⁺/LTP⁻ signal pair, during the LTP⁻ time slot, the internal neuron transmits a negative LTP⁻ signal of the LTP⁺/LTP⁻ signal pair, during the LTD⁺ time slot, the internal neuron can transmit a positive LTD⁺ signal of an LTD⁺/LTD⁻ signal pair, and during the LTD⁻ time slot, the internal neuron transmits a negative LTD⁻ signal of the LTD⁺/LTD⁻ signal pair;
wherein, during the first frame coincident with spiking, an internal neuron transmits
a spike signal to one or more outputs during the COMM time slot,
a maximum LTP⁺ signal to one or more outputs during the LTP⁺ time slot,
a maximum LTP⁻ signal to one or more outputs during the LTP⁻ time slot,
a maximum LTD⁻ signal to one or more outputs during the LTD⁺ time slot,
a maximum LTP⁻ signal to one or more inputs during the LTP⁺ time slot,
a maximum LTD⁺ signal to one or more inputs during the LTD⁺ time slot, and
a maximum LTD⁻ signal to one or more inputs during the LTD⁻ time slot; and
wherein a non-spiking neuron, during each frame following spiking, transmits
an LTP⁺ signal to one or more outputs during the LTP⁺ time slot of a magnitude representing a current value of an LTP function that exponentially decays from a maximum value at the time of spiking,
an LTP⁻ signal to one or more outputs during the LTP⁻ time slot of a magnitude representing a current value of an LTP function that exponentially decays from a maximum value at the time of spiking,
an LTD⁺ signal to one or more inputs during the LTD⁺ time slot of a magnitude representing a current value of an LTP function that exponentially decays from a maximum value at the time of spiking, and
an LTD⁻ signal to one or more inputs during the LTD⁻ time slot of a magnitude representing a current value of an LTP function that exponentially decays from a maximum value at the time of spiking.
